(19) United States
(12) Patent Application Publication
(10) Pub. No.: US 2026/0285365 A1
(43) Pub. Date: Sep. 24, 2026

(54) TRAJECTORY SELECTION AND PLANNING BASED ON RULE VIOLATIONS

(71) Applicant: Motional AD LLC, Boston, MA (US)

(72) Inventors: Sandip Aine, Pittsburgh, PA (US); Nathan Spielberg, Boston, MA (US); Luke Fletcher, Boston, MA (US); Forbes Howington, Louisville, CO (US); Puneet Singhal, Pittsburgh, PA (US)

(21) Appl. No.: 19/689,115

(22) Filed: May 27, 2026

Related U.S. Application Data
(63) Continuation of application No. PCT/US2024/057536, filed on Nov. 26, 2024.
(60) Provisional application No. 63/603,271, filed on Nov. 28, 2023.

(51) Int. Cl. B60W 60/00; B60W 30/095

(52) U.S. Cl. CPC B60W 60/0011; B60W 30/095; B60W 2420/403; B60W 2420/408; B60W 2554/801; B60W 2554/802; B60W 2710/18; B60W 2710/20

(57) ABSTRACT

Provided are methods for trajectory generation using a plurality of trajectories, which can include generating a first trajectory for a vehicle based on a first set of criterion, generating a second trajectory for the vehicle based on a second set of criterion, determining at least one of a probability of or a distance from a violation of a behavioral rule by the vehicle, selecting a particular trajectory from the first trajectory and the second trajectory based on the at least one of the probability of or the distance from the violation of the behavioral rule, and determining a path for the vehicle to operate along based on the particular trajectory. Systems and computer program products are also provided.

### RELATED APPLICATIONS

Any and all applications for which a foreign or domestic priority claim is identified in the Application Data Sheet as filed with the present application are incorporated by reference under 37 CFR 1.57 and made a part of this specification. This application is a continuation of PCT Patent Application No. PCT/US2024/057536, filed on Nov. 26, 2024, entitled TRAJECTORY SELECTION AND PLANNING BASED ON RULE VIOLATIONS, which claims the priority benefit of U.S. Provisional Patent Application 63/603271, filed Nov. 28, 2023, entitled TRAJECTORY SELECTION AND PLANNING BASED ON RULE VIOLATIONS, each of which is incorporated herein by reference in its entirety.

### BACKGROUND

Self-driving vehicles typically use many decisions during operation. Executing the decisions can be difficult and complicated due to potential driving requirements enforced by traffic laws, cultural expectations, safety considerations, driving norms, etc. as well as their relative priorities.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 are diagrams of an implementation of a process for graph exploration for trajectory generation based on a hierarchical plurality of rules;

FIG. 6 illustrates an example scenario for autonomous vehicle operation using graph exploration with behavioral rule checks;

FIG. 7 illustrates an example flow diagram of a process for vehicle operation using behavioral rule checks to determine a fixed set of trajectories;

FIG. 8 is an illustration of iteratively growing graphs to find a trajectory after-the-fact;

FIG. 9 is a diagram of system that calculates priorities according to a hierarchical plurality of rules;

FIG. 10 is a flowchart of a process for graph exploration for trajectory generation;

FIG. 11 is a block diagram illustrating an example of a planning system;

FIG. 12 is an example environment in which a vehicle including one or more components of an autonomous system can be implemented;

FIG. 13A is a flow diagram illustrating an example identification of a plurality of trajectories for a vehicle;

FIG. 13B is a flow diagram illustrating an example identification of a path for a vehicle;

FIG. 14 is a flow diagram illustrating an example of a routine implemented by one or more processors to determine a path for a vehicle.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement a planning system that generates and selects a trajectory for a vehicle (e.g., an autonomous vehicle). The planning system can receive location data that identifies a location of the vehicle and/or route data that identifies a source and/or destination of the vehicle within an environment. The vehicle can navigate from the source to the destination in accordance with a route. The route may be based on different combinations of trajectories or paths between poses. A combination of trajectories may cause navigation from the source to the destination, however, different combinations of trajectories may result in different paths. To build the path for the vehicle, the planning system can generate a plurality of trajectories and select a trajectory for the vehicle based on sensor data (e.g., indicating a location or presence of a pedestrian, another vehicle, etc.). The route may be required to satisfy particular rules such as traffic laws, cultural expectations of driving behavior, reaching the destination by a particular time, etc. Particular trajectories may be selected for the route based on the rules violated by each trajectory (e.g., a trajectory that causes a violation of the lowest priority rule, a trajectory that causes a violation of a rule with a priority below a threshold). For a portion of the route and a particular planning step, the planning system may generate a first subset of trajectories (e.g., a first trajectory generated by a first trajectory generator) and a second subset of trajectories (e.g., a second trajectory generated by a second trajectory generator). The first subset of trajectories may be generated based on a first set of criterion (e.g., various functions, objectives, goals, processes, models, sensor data, etc.) and the second subset of trajectories may be generated based on a second, different set of criterion (e.g., a safety objective). The system may generate the first subset of trajectories at a lower frequency as compared to the second subset of trajectories such that the first subset of trajectories may not account for rapid changes (e.g., changes requiring a response in less than 100 ms) within the environment or objects acting in an unexpected manner. For all or a portion of the planning steps, the planning system may verify that a selected trajectory from the first subset of trajectories does not result in a probability of or a distance from a violation of a rule by the vehicle that satisfies (e.g., is less than, greater than, within, matches, etc.) a particular threshold. If the previously selected trajectory does result in a probability of or a distance from a violation of a rule by the vehicle that satisfies a particular threshold, the planning system can select a trajectory (e.g., a safety trajectory) from the second subset of trajectories instead of the previously selected trajectory. Based on the selected trajectory, the planning system can determine a path for the vehicle. As a non-limiting example, the planning system generates the first and second subsets of trajectories and selects a trajectory from the generated first and second subsets of trajectories.

By virtue of the implementation of systems, methods, and computer program products described herein, a system can generate a path for a vehicle that includes a trajectory from a plurality of trajectories that includes a first subset of trajectories and a second subset of trajectories. The system can generate a plurality of trajectories that are associated with a plurality of planning steps and represent a plurality of routes through an environment. To verify that the plurality of trajectories satisfy safety constraints, prior to implementation of a trajectory from the first subset of trajectories, at all or a portion of the plurality of planning steps, the system can determine whether a violation of a particular rule (also referred to herein as a rule violation) with a particular priority or any rule (e.g., colliding with an object in the environment, not maintaining a particular distance from another vehicle, etc.) is predicted to occur (e.g., by a vehicle operating according to a trajectory of the first subset of trajectories) with a probability (e.g., likelihood) matching, within, or greater than a particular threshold (e.g., 75%, 80%, 95%, etc.). In some cases, the system can determine whether the vehicle is predicted to match, be within, or be less than a particular distance from a violation of a particular rule or any rule (e.g., five feet from colliding with an object). Based on determining the first subset of trajectories is predicted to cause a rule violation (and/or the vehicle is predicted to match, be within, or be less than a particular distance from a rule violation), the system can automatically select a trajectory from the second subset of trajectories (e.g., a safety trajectory, a safety-oriented trajectory, a reflexive trajectory, a safety-focused trajectory, etc.) for the vehicle in a rapid manner (e.g., 50 ms, 45 ms, 40 ms, etc.). For example, the second subset of trajectories may include one or more swerving trajectories or braking trajectories, and the system may select the trajectory from the second subset of trajectories to increase a safety of the vehicle, passenger, or person outside the vehicle, as compared to selecting a trajectory from the first subset of trajectories. Therefore, the system can select safer trajectories from the plurality of trajectories for a vehicle and generate a path for the vehicle. Based on the generated path, the system can more accurately and efficiently perform automated vehicle testing to improve automated vehicle driving behavior. In some cases, the system can generate a path for a vehicle, in real time, by identifying a set of trajectories (including a first and second subset of trajectories), determining a likelihood of a rule violation and/or a distance from a rule violation, and selecting a trajectory for the path for the vehicle. The use of the second subset of trajectories that may include shorter term trajectories that are based on safety objectives enables the system to identify changes more rapidly within an environment and implement trajectories based on the changes within the environment. Such a trajectory selection can improve the quality and performance of the vehicle.

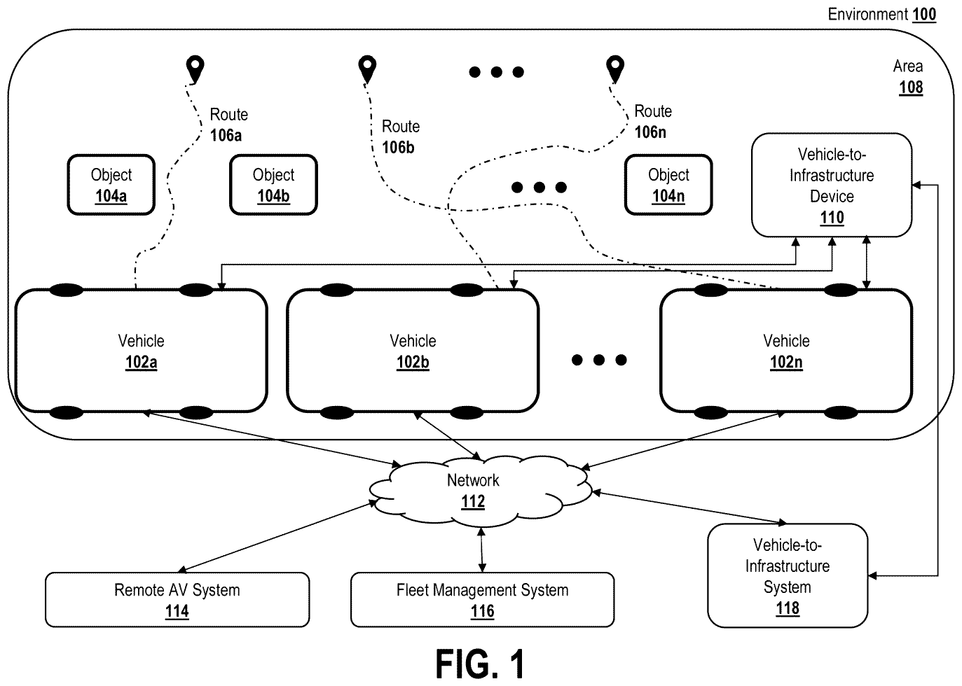

Referring now to FIG. 1, illustrated is an example environment 100 in which vehicles that include autonomous systems, as well as vehicles that do not, are operated. As illustrated, environment 100 includes vehicles 102a-102n, objects 104 a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

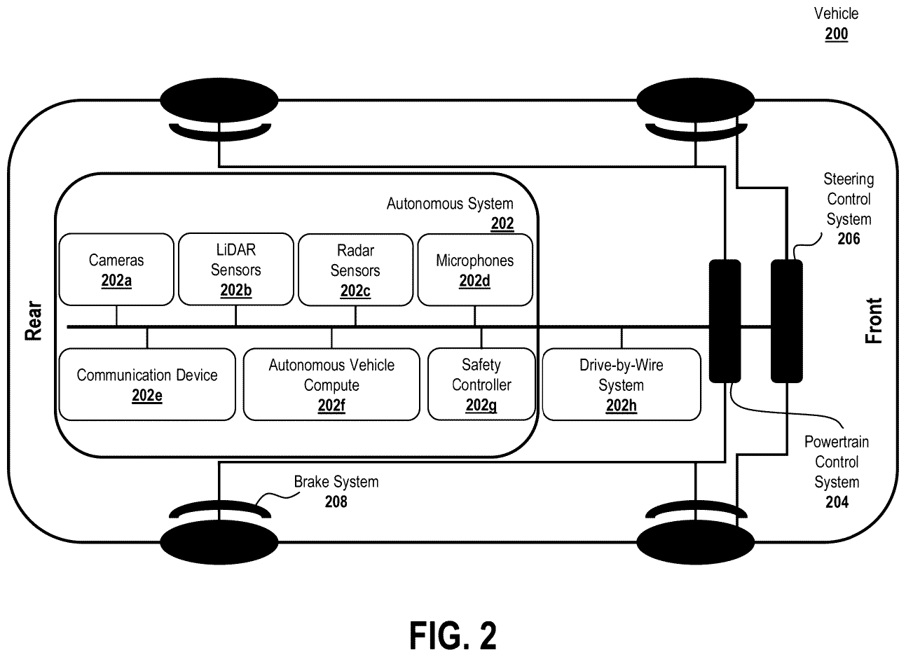

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

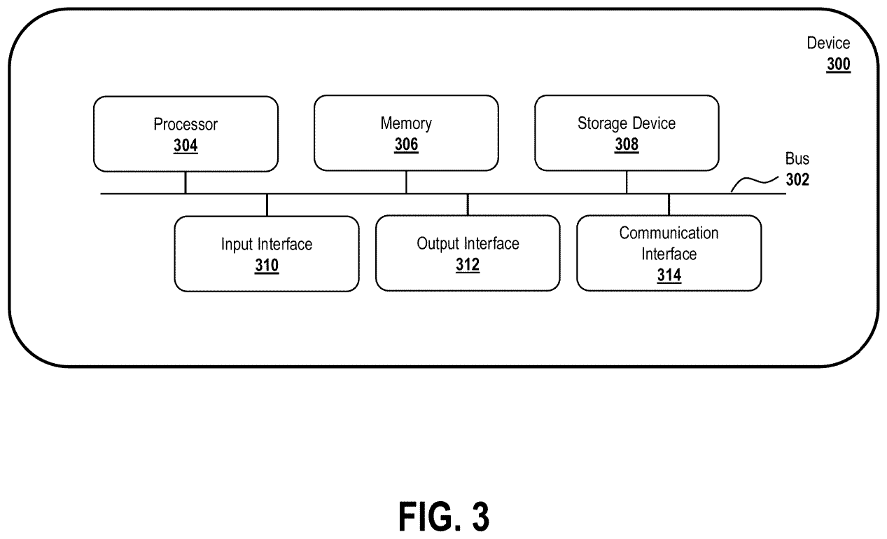

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202 a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle compute 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102) and/or one or more devices of network 112 (e.g., one or more devices of a system of network 112). In some embodiments, one or more devices of vehicles 102 (e.g., one or more devices of a system of vehicles 102) and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

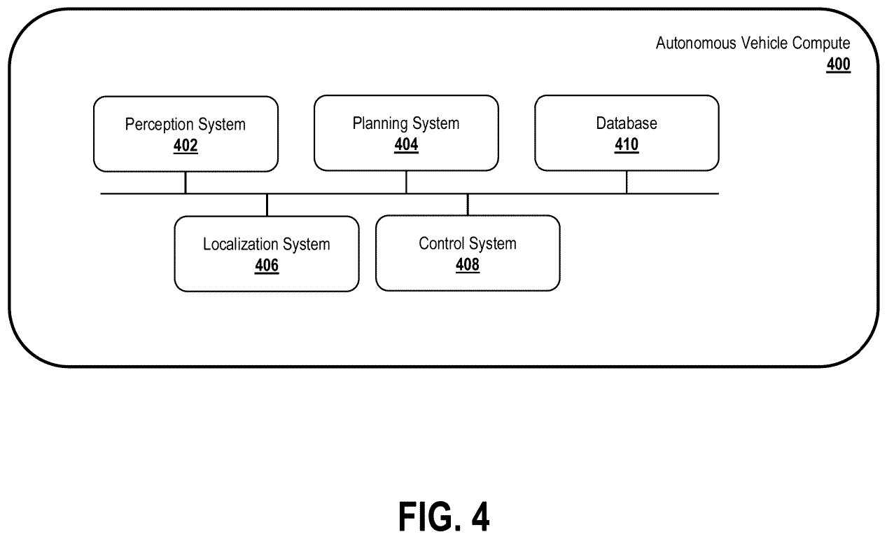

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

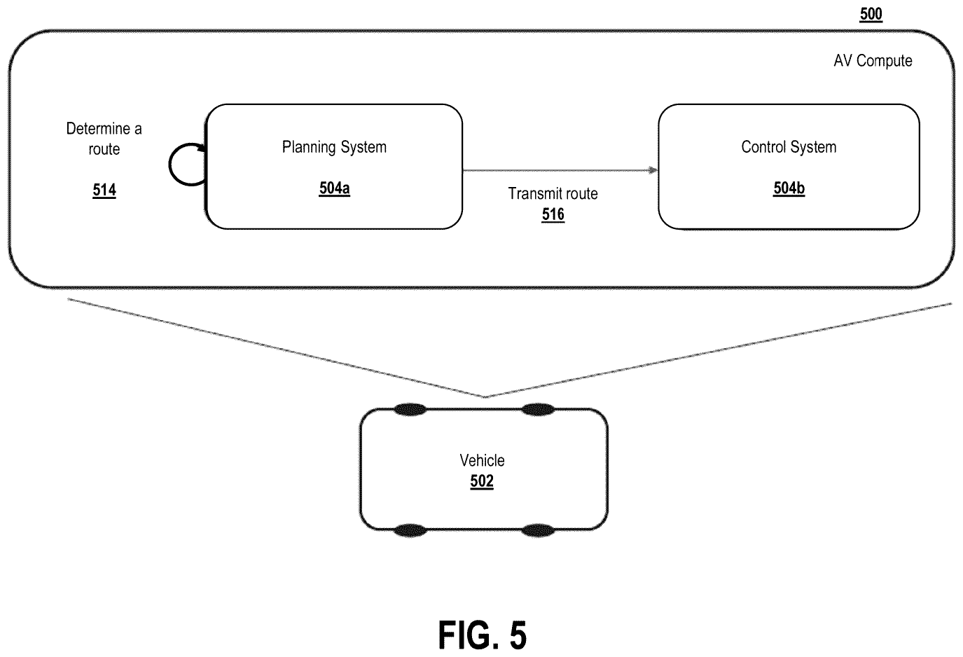

Referring now to FIG. 5, illustrated is a diagram of an implementation 500 of a process for graph exploration for trajectory generation based on a hierarchical plurality of rules. In some embodiments, implementation 500 includes planning system 504a. In some embodiments, planning system 504a is the same as or similar to planning system 404 of FIG. 4. The output of a planning system 504a can be a route from a start point (e.g., source location or initial location) to an end point (e.g., destination or final location). In the example of FIG. 5, the planning system 504a determines the route at reference number 514 and transmits the route at reference number 516 to a control system 504b. During vehicle operation, the control system operates the vehicle to navigate the route. In some embodiments, the route and other AV compute data is stored for after-the fact evaluation of routes selected by the AV to navigate from a start point to an end point. Generally, the route is defined by one or more segments. For example, a segment is a distance to be traveled over at least a portion of a street, road, highway, driveway, or other physical area appropriate for automobile travel. In some examples, e.g., if the AV is an off-road capable vehicle such as a four-wheel-drive (4WD) or all-wheel-drive (AWD) car, SUV, pick-up truck, or the like, the route includes “off-road” segments such as unpaved paths or open fields.

The planning system 504a can output lane-level route planning data (in addition to or instead of the route). The lane-level route planning data can be used to traverse segments of the route based on conditions of a particular segment at a particular time. In some embodiments, the lane-level route planning data is stored for after-the-fact evaluation using graph exploration as described herein. During operation, the lane-level route planning data can be used to traverse segments of the route based on conditions of the particular segment at a particular time. For example, if the route includes a multi-lane highway, the lane-level route planning data includes trajectory planning data that the AV can use to choose a lane among the multiple lanes (e.g., based on whether an exit is approaching, whether one or more of the lanes have other vehicles, or other factors that vary over the course of a few minutes or less as the vehicle moves along a route). Similarly, in some implementations, the lane-level route planning data includes speed constraints specific to a segment of the route. For example, if the segment includes pedestrians or un-expected traffic, the speed constraints may limit the AV to a travel speed slower than an expected speed, e.g., a speed based on speed limit data for the segment.

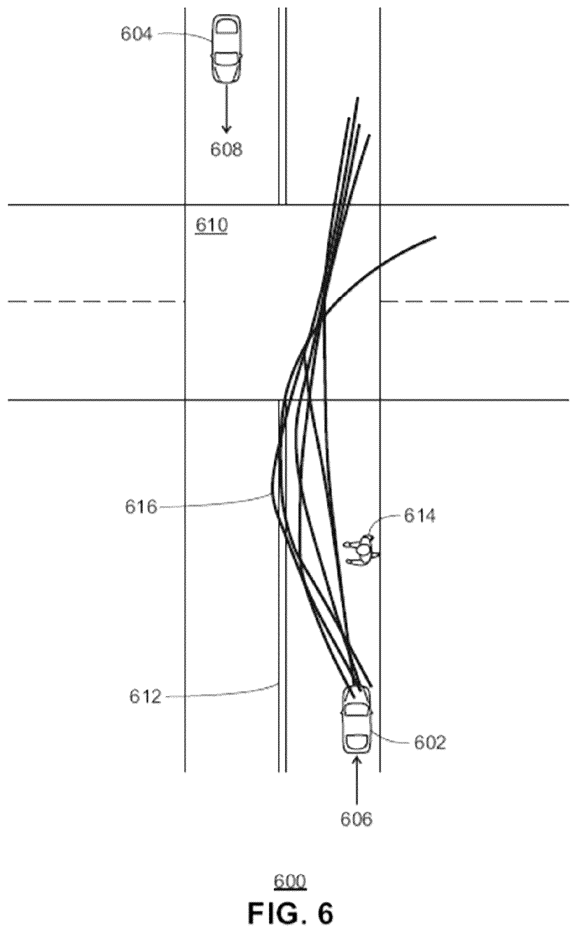

FIG. 6 illustrates an example scenario for AV 602 operation using graph exploration with behavioral rule checks, in accordance with one or more embodiments. The AV 602 may be, for example a vehicle 102 as illustrated and described in more detail with reference to FIG. 1 or a vehicle 200 as illustrated and described in more detail with reference to FIG. 2. The AV 602 operates in an environment 600, which may be an environment 100 as illustrated and described in more detail with reference to FIG. 1. In the example scenario illustrated in FIG. 6, the AV 602 is operating in lane 606 on approach to the intersection 610. Similarly, another vehicle 604 is operating in lane 608 on approach to the intersection 610. The flow of traffic in lane 606 is opposite to the flow of traffic in lane 608, as indicated by the arrows. There is a double line 612 separating lane 606 from lane 608. However, there is no physical road divider or median separating lane 606 from lane 608. The traffic rules in the environment 600 prohibit a vehicle from crossing the double line 612 or exceeding a predetermined speed limit (e.g., 45 miles per hour) in accordance with generally understood rules of the road.

The AV 602 is operating in the lane 606 to navigate to a destination beyond the intersection 610. As illustrated, a pedestrian 614 is located in the lane 606, blocking the lane 606. Other objects can block the AV's planned trajectory, such as incidents that block a lane of travel, vehicle breakdowns, construction, cyclists, and the like. In some embodiments, the AV 602 uses a perception system 402 to identify the objects, such as the pedestrian 614. The perception system 402 is illustrated and described in more detail with reference to FIG. 4. Generally, the perception system 402 classifies objects into types such as automobile, roadblock, traffic cones, etc. The classifications are provided to the planning system 404. The planning system 404 is illustrated and described in more detail with reference to FIG. 4.

The AV 602 determines that the lane 606 is blocked by the pedestrian 614. In examples, the AV 602 detects the boundaries of the pedestrian 614 based on characteristics of data points (e.g., sensor data) detected by the sensors of FIG. 2. To reach the destination, a planning system 404 (FIG. 4) of the AV 602 generates the trajectories 616. Operating the AV 602 in accordance with one or more of the trajectories 616 causes the AV 602 to violate a traffic rule and cross the double line 612 to maneuver around the pedestrian 614 so that the AV 602 reaches its destination. Some of the trajectories 616 cause the AV 602 to cross the double line 612 and enter lane 608, in the path of the vehicle 604. The AV 602 uses a hierarchical plurality of rules (e.g., a hierarchical set of rules of operation) to provide feedback on the driving performance of AV 602. The hierarchical plurality of rules is sometimes referred to as a stored behavioral model or a rulebook. In some embodiments, the feedback is provided in a pass-fail manner. The embodiments disclosed herein detect when the AV 602 (e.g., the planning system 404 of FIG. 4) generates trajectories 616 that violate rules (e.g., behavioral rules) that do not satisfy a threshold priority, and determines whether the AV 602 could have generated an alternative trajectory that would have violated no rules or one or more rules that do satisfy the threshold priority (e.g., lower-priority behavioral rules) (e.g., behavioral rules with a lower priority than the trajectories 616 based on the hierarchical plurality of rules) and would not have violated one or more rules that do not satisfy the threshold priority. The occurrence of such a detection denotes a failure of the motion planning process. The present techniques use graph exploration to heuristically determine a trajectory from the trajectories 616 that navigate past the pedestrian 614 in lane 606 and reaches a destination (e.g., goal). In some embodiments, the trajectory is a trajectory that begins at a starting pose and violates a behavioral rule with a priority level that satisfies (e.g., is below) a threshold priority, such as the behavioral rule with the lowest priority (e.g., the lowest priority behavioral rule) as compared to the priority of behavioral rules violated by other trajectories of the trajectories 616 or a behavioral rule with a priority level that is lower than one or more priority levels of other behavioral rules. In some cases, priority level of behavioral rules may be assigned a value within a range of values and the threshold priority may correspond to a particular value that is within the range of values such that a behavioral rule assigned a value that is below the particular value is considered to have satisfied the threshold priority and therefore available to be used to operate the vehicle.

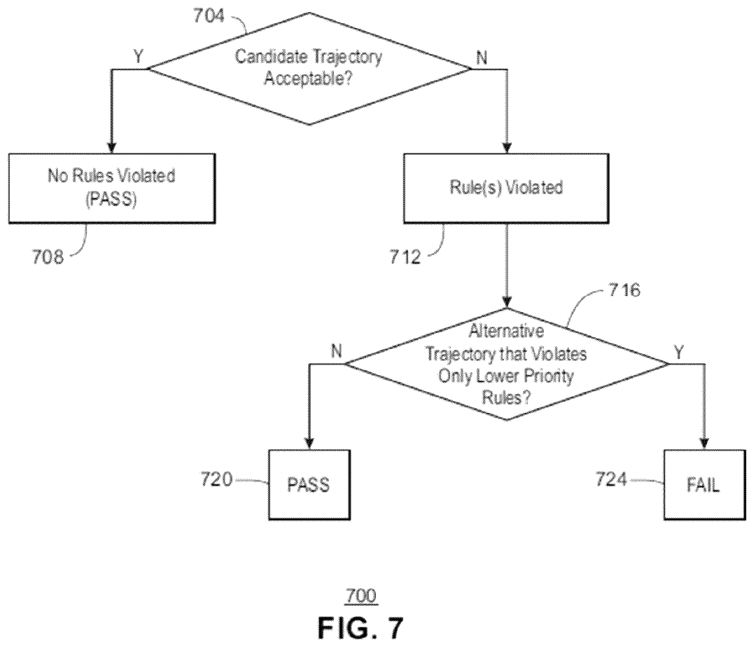

In some embodiments, at least one processor receives sensor data after the operation of the AV. The sensor data is representative of scenarios encountered by the AV while navigating through the environment. Hierarchical rules of the hierarchical plurality of rules are applied to scenarios simulated by an AV stack to modify and improve the AV development after-the-fact (e.g., after operation of the AV, where sensor data is captured). In examples, this offline framework is configured to develop a transparent and reproducible rule-based pass/fail evaluation of AV trajectories in test scenarios. For example, in an offline framework, a given trajectory output by the planning system 404 is rejected if a trajectory that leads to a lesser violation of the rule priority structure (e.g., a rule with a lower priority as compared to the priority of the rule violated by the trajectory) is found. The planning system is modified and improved based on, at least in part, the rejected trajectory and data associated with the rejected trajectory. In some embodiments, the present techniques receive a fixed set of trajectories generated after-the-fact from a given scenario and determines a particular trajectory to evaluate if the AV passes or fails a predetermined test. The present techniques use a set of fixed trajectories to create a graph. In some embodiments, the graph is an edge weighted graph and weights are assigned to edges that correspond to trajectories based on rule violations. Each trajectory can be associated with one or more costs, each cost corresponding to a rule violation. Determining the fixed set of trajectories is described with respect to FIG. 7.

FIG. 7 illustrates an example flow diagram of a process 700 for vehicle operation using behavioral rule checks to determine a fixed set of trajectories. In some embodiments, the process of FIG. 7 is performed by the vehicle 200 of FIG. 2, the device 300 of FIG. 3, the autonomous vehicle compute 400 of FIG. 4, or any combinations thereof. In some embodiments, at least one processor located remotely from a vehicle performs the process 700 of FIG. 7. Likewise, embodiments may include different and/or additional steps, or perform the steps in different orders.

At block 704, it is determined that a trajectory (e.g., trajectories 616) for the AV 602 is acceptable (e.g., whether the trajectory violates a rule of the hierarchical plurality of rules). The trajectories 616 and AV 602 are illustrated and described in more detail with reference to FIG. 6. In some examples, a trajectory is determined to be acceptable based on the hierarchical plurality of rules. If no rules are violated by the trajectory, the trajectory is acceptable and the process moves to step 708 and the planning system 404 and AV behavior pass the verification checks. The planning system 404 is illustrated and described in more detail with reference to FIG. 4.

If a rule is violated by the trajectory, the process moves to block 712 to determine the rule(s) violated by the trajectory. The violated rule is denoted as a first behavioral rule having a first priority. The process moves to block 716. At block 716, the processor determines whether an alternative trajectory is available for the AV 602 that violates a behavioral rule with a lower priority than the first priority. For example, the processor generates multiple alternative trajectories for the AV 602 based on sensor data associated with a scenario. In some embodiments, the sensor data characterizes information associated with the AV, information associated with the objects, information associated with the environment, or any combinations thereof. The processor identifies whether a second trajectory from the multiple alternative trajectories is available that violates a second behavioral rule of the hierarchical plurality of rules with a second priority that is less than the first priority (e.g., the second trajectory does not violate a behavioral rule with a priority that is greater than or equal to the first priority). In some examples, if no other trajectory is available that violates (e.g., only violates) a second behavioral rule with a priority lower than the first priority, the process moves to block 720 and the planning system 404 passes the verification checks. At block 716, if an alternative trajectory is available for the AV 602 that violates a behavioral rule with a lower priority than the first priority, the planning system 404 fails the verification checks. Thus, the planning system 404 can identify a trajectory for a vehicle that violates a rule with a particular priority in order to avoid violating a rule with a higher comparative priority (e.g., a worse scenario).

In some examples, an AV is operable according to a hierarchical plurality of rules. Each behavioral rule has a priority with respect to each other rule. For example, a hierarchical plurality of rules (e.g., a rulebook) can include the following rules, in increasing order of priority: 1: maintain a predetermined speed limit; 2: stay in lane; 3: maintain a predetermined clearance; 4: reach goal; 5: avoid collisions. In some examples, the priority represents a risk level of a violation of the behavioral rules. The hierarchical plurality of rules may, in some cases, be implemented as a formal framework to specify driving requirements enforced by traffic laws, cultural expectations, safety considerations, driving norms, etc. as well as their relative priorities. In certain cases, the hierarchical plurality of rules may be implemented as a pre-ordered set of rules having violation priorities (e.g., scores) that capture the hierarchy of the rule priorities. Hence, the hierarchical plurality of rules enables AV behavior specification and assessment in conflicting scenarios.

Referring again to FIG. 6, consider the case where a pedestrian 614 enters the lane in which the AV 602 is traveling. The hierarchical plurality of rules may indicate that the highest priority of the AV 602 is to avoid collision with the pedestrian 614 and other vehicle 604 (e.g., satisfy rule 5: avoid collision, highest priority in the exemplary hierarchical plurality of rules) at the cost of violating lower priority rules, such as reducing speed to less than a minimum speed limit (e.g., violation of rule 1: maintain a predetermined speed limit) or deviating from a lane (e.g. violation of rule 2: stay in lane). For example, generation of the hierarchical plurality of rules may be an after-the-fact prioritization of actions the AV should take based on perfect information (e.g., knowing predetermined values or states) associated with the scenario.

In some cases, the AV may determine a trajectory of the AV that causes a violation of a behavioral rule such that the AV exceeds a predetermined speed limit (e.g., 45 mph). For example, the rule (1) may be to maintain a predetermined speed limit, denoting that the AV should not violate the speed limit of the lane it is traveling in. In the aforementioned example, the priority of rule (1) is lower than the priority of rule (5): avoid collisions, rule (4): reach goal, rule (3): maintain clearance, and/or rule (2): stay in lane. Thus, the AV may violate rule (1) to avoid violating rules (2), (3), (4) and/or (5).

In an embodiment, the AV may determine a trajectory of the AV that causes a violation of a behavioral rule such that the AV stops before reaching a destination. In examples, rule (2) may be to stay in lane, denoting that the AV should stay in its own lane. The priority of rule (2) is lower than the priority of rule (5): avoid collisions, rule (4): reach goal, and/or rule (3): maintain clearance. Thus, the AV may violate rule (1) or rule (2) to avoid violating rules (3), (4), and/or (5).

In an embodiment, the AV may determine a trajectory of the AV that causes a violation of a behavioral rule such that a lateral clearance between the AV and the objects near the AV decreases below a threshold lateral distance. For example, rule (3) may be to maintain a predetermined clearance, denoting that the AV should maintain a threshold lateral distance (e.g., one half car length or 1 meter) from any other object (e.g., pedestrian 614). The priority of rule 3 is lower than the priority of rule (5): avoid collisions, and/or rule (4): reach goal, and the AV can violate rules (1), (2), or (3) to avoid violating rules (4) and/or (5).

In some embodiments, the sets of alternative trajectories are generated based on driver and/or driving behavior. For example, the trajectories may include trajectories generated based on driver behavior (e.g., human driver behavior), trajectories generated based on driving behavior (e.g., trajectories generated by a model), training trajectories, or any other trajectories. The trajectories may be grouped into a plurality of trajectory sets, and can be stitched together to generate a graph of trajectories. In some embodiments, the trajectory sets may represent some or all of the trajectories the AV can take with respect to a starting pose (e.g., location, speed, heading, and/or acceleration). Accordingly, the trajectories may include paths that are possible in view of a pose.

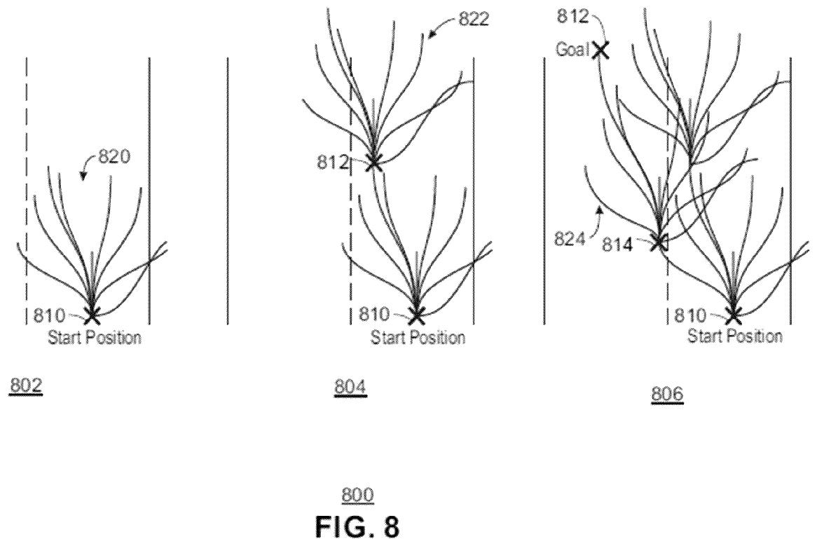

FIG. 8 is an illustration of iteratively growing graphs 800 to determine a trajectory that violates a rule with a priority level that satisfies (e.g., is below) a threshold priority (e.g., such as a trajectory that violates a rule with a lowest priority (and/or violates no rules) as compared to rules violated by other trajectories after-the-fact). In some embodiments, the generated graphs 802, 804, and 806 are explored to determine a trajectory that represents a preferred path for the vehicle to take through an environment. The preferred path can be used to compare a trajectory taken by the AV in a same scenario associated with the determined trajectories according to the present techniques. The graph generation enables evaluation of an AV response in view of a determined trajectory.

In some embodiments, a preferred trajectory changes over time or based on different locations. Put another way, a preferred trajectory at a first pose might cause a violation of higher priority rules at subsequent poses. For example, during travel through an environment, based on a preferred trajectory at a first pose, the AV can get stuck (e.g., unable to plan a path forward) or left to follow a path that creates a particular rule violation.

In some cases, trajectories are generated without positive reinforcement of selected (e.g., traversed or navigated) trajectories as the AV travels. In traditional techniques, generated trajectories can deteriorate over time. The present techniques evaluate candidate trajectories at a series of poses, such that a subset of the trajectories at a series of poses are selected according to the hierarchical plurality of rules. The trajectories are iteratively traversed to generate a graph of trajectories from a starting pose to a goal pose. The present techniques create a graph based on the fixed set of trajectories. In some embodiments, the generated graph captures vehicular dynamics from the fixed trajectory sets using the series of poses.

In the example of FIG. 8, a first pose 810 of the AV is at the start position. From the start position, a set of alternative trajectories 820 for a vehicle at a first pose 810 (e.g., root node of the corresponding graph) are generated, the set of alternative trajectories representing operation of the vehicle from the first pose 810. In the set of alternative trajectories, one or more trajectories are determined (e.g., trajectories that cause a violation of rules from the hierarchical plurality of rules with a priority lower than the priority of rules violated by other trajectories from the set of alternative trajectories 820). The determined trajectories are used to determine next poses, and a next set of alternative trajectories 822 and 824 are generated from the next poses. In particular, a next pose 812 (e.g., a goal/destination) is evaluated to generate a next set of alternative trajectories 822. A next pose 814 is evaluated to generate a next set of alternative trajectories 824. In some embodiments, sets of alternative trajectories are iteratively generated until the next pose 812 is reached.

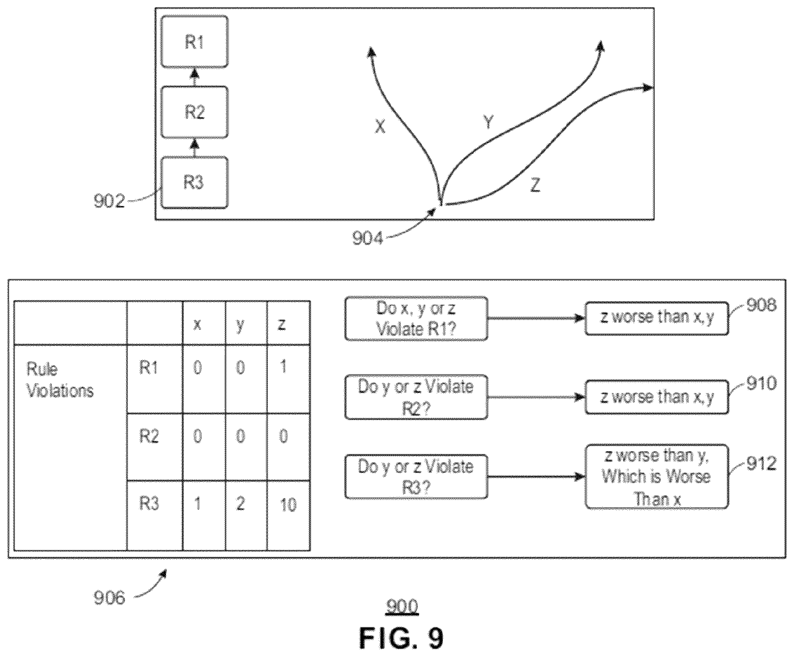

As illustrated in FIG. 8, the graphs 802, 804, and 806 are generated by calculating a set of alternative trajectories 820 at a first pose 810 in a given scenario. From the set of alternative trajectories 820, the one or more trajectories (e.g., a random or pseudo-random subset of the set of alternative trajectories 820) are determined. In some examples, one or more trajectories are selected based on causing a violation of rules of the hierarchical plurality of rules with a priority level that satisfies (e.g., is below) a threshold priority (e.g., such as a trajectory that causes a violation of a rule with the lowest (or lower) priority as compared to rule violations of other trajectories of the set of alternative trajectories 820). For example, a preordered list of priorities according to the rule violations can be associated with each trajectory of the graph. An example of this priority is described below with respect to FIG. 9. Generally, the numbers of trajectories selected for each set of trajectories (e.g., each layer of graph growing) enables tuning of the quality of the graph as compared to the speed of computing the graph. A larger number of trajectories can cause exponential increases in computation time, however the quality of the resulting graph also increases.

In some embodiments, the set of alternative trajectories 820 is grown with the next set of alternative trajectories 822, 824. For example, a next pose (e.g., next pose 812, 814) at the end of a selected trajectory of the set of alternative trajectories 820 is used to iteratively generate a next (e.g., random) set of alternative trajectories (e.g., the next set of alternative trajectories 822, 824). The trajectories that are retained from the next set of alternative trajectories can be trajectories that cause a violation of rules from the hierarchical plurality of rules with a priority lower than the priority of rules violated by other trajectories from the next set of alternative trajectories. Graph growth can continue until one or more trajectories are generated that reach the next pose 812 or a timeout occurs. The timeout may be a predetermined period of time before graph generation is terminated. In some examples, the timeout can be canceled or overridden to continue graph generation. The trajectories (e.g., the path) selected for the graph can be those trajectories from the first pose to the goal that cause violation of no rule or cause violation of a rule that satisfies (e.g., are below) a threshold priority (e.g., such as a trajectory that causes a violation of a rule that has a lowest priority according to the hierarchical plurality of rules).

FIG. 9 is a diagram of system 900 that calculates a priority (e.g., a score) for all or a portion of trajectories according to a hierarchical plurality of rules. A path can include multiple trajectories and the system 900 can calculate a priority of the path based on a highest priority of a trajectory of the path as compared to other trajectories of the path, a cumulative priority of the priorities of all or a portion of the trajectories of the path, etc. In the example of FIG. 9, a hierarchical plurality of rules 902 provides three exemplary hierarchical rules: R1 (highest priority), R2 (next highest priority), R3 (lowest priority). The system 900 can assign all or a portion of the hierarchical rules a base priority based on the hierarchical plurality of rules 902. The system 900 can further determine a priority of a violation of a rule by a trajectory based on the base priority and a level of a violation of the rule. For example, the hierarchical plurality of rules 902 indicates that a violation of rule R1 has a priority of 1 and the system 900 determines that a singular violation of rule R1, a lesser violation of rule R1 (as compared to other violations), etc. has a priority of 1 and multiple violations of rule R1, a greater violation of rule R1 (as compared to other violations), etc. has a priority of 2. Additionally, a fixed set of trajectories 904 includes a trajectory x, trajectory y, and trajectory z. The fixed set of trajectories may be the same as or similar to the trajectories 616 (FIG. 6) or trajectories 820, 822, or 824 of FIG. 8. In some embodiments, the fixed set of trajectories represent all or a portion of the actions that vehicles can make in traffic situations. In some examples, the fixed set of trajectories is generated using a planning system of an AV (e.g., planning system 404 of FIG. 4) in response to simulation in a predetermined scenario. In examples, the predetermined scenario is represented by AV compute inputs and outputs as the AV travels from a starting pose toward a destination.

In some embodiments, the priority represents a comparative level of a rule violation as compared to the level of rule violation by one or more other trajectories. For example, each individual rule is independently evaluated and compared to all or a portion of the other trajectories. The priority can be based on, at least in part, the particular rule. For example, for a rule associated with a minimum clearance between the AV and a pedestrian, the priority is based on the number of violations (e.g., instantaneous violations) of clearance associated with the AV and one or more pedestrians, the distance between the AV and a pedestrian, etc. In this example, the violations are entering a space near the pedestrian by violating a clearance between the AV and the pedestrian. Each trajectory can be ranked based on the number of violations, the type of violations, the magnitude of violations, etc. according to a lexicographic order.

In the example of FIG. 9, system 900 identifies rule violations caused by all or a portion of the fixed set of trajectories to determine rule violation priorities 906 for each trajectory. In particular, the system 900 evaluates all or a portion of the rules to determine the rule violation priorities for a trajectory. At evaluation 908, the system 900 evaluates rule R1 to determine if trajectory x, trajectory y, or trajectory Z violates rule R1. In the example of FIG. 9, the system 900 determines that trajectory z violates rule R1, while trajectory x and trajectory y do not violate rule R1. The system 900 assigns trajectory z a priority of 1 with respect to rule R1. The system 900 assigns trajectories x and y a priority of 0 with respect to rule R1. At evaluation 910, the system 900 evaluates rule R2 to determine if trajectory x, trajectory y, or trajectory Z violates rule R2. In the example of FIG. 9, no trajectory violates rule R2. The system 900 assigns each trajectory a priority 0 with respect to rule R2. At evaluation 908 trajectory z is the only trajectory that violates R1, so the system 900 assigns a priority for violation of rule R1 to trajectory z. At evaluation 910, no trajectory violates rule R2 so the system 900 does not assign a priority for violation of rule R2 to any of the trajectories (or assigns a priority of 0).

At evaluation 912, the system 900 evaluates rule R3 to determine if trajectory x, trajectory y, or trajectory z violates rule R3. In the example of FIG. 9, the system 900 determines trajectory z violates rule R3 worse than trajectory y violates rule R3, which in turn violates rule R3 worse than trajectory x. violates rule R3 The system 900 assigns trajectory z a priority of 10 with respect to rule R3, where 10 is the maximum number of violations of rule R3. The system 900 assigns trajectory x a priority of 1, and trajectory y a priority of 2 with respect to rule R3.

In some examples, from a set of fixed trajectories, the system 900 can determine a random subset of the trajectories. The determined trajectories can be the trajectories that have a priority above a predetermined threshold with respect to all or a portion of the rules. In some examples, the system 900 can select all or a portion of the trajectories that have a priority above the predetermined threshold according to the hierarchical plurality of rules for the graph. In some embodiments, the system 900 generates a second set of trajectories from poses located at the end of the determined trajectories (e.g., the system grows the determined trajectories). Graph growth can continue until one or more paths of trajectories are generated that reach the goal pose. The system 900 can select a path for the graph from the first pose to the goal pose that cause violation of no rule or cause violation of a rule that satisfies (e.g., is below) a threshold priority (e.g., such as a trajectory that causes a violation of a rule that has a lowest priority (e.g., cumulative or total priority) as compared to other paths that reach the goal pose according to the hierarchical plurality of rules). In this manner, the system 900 can generate the graph as a guided heuristic using the behavior modeling and prediction data set. In some examples, the present techniques do not converge on a singular trajectory or path. For example, the system 900 can obtain multiple trajectories or paths with a particular priority.

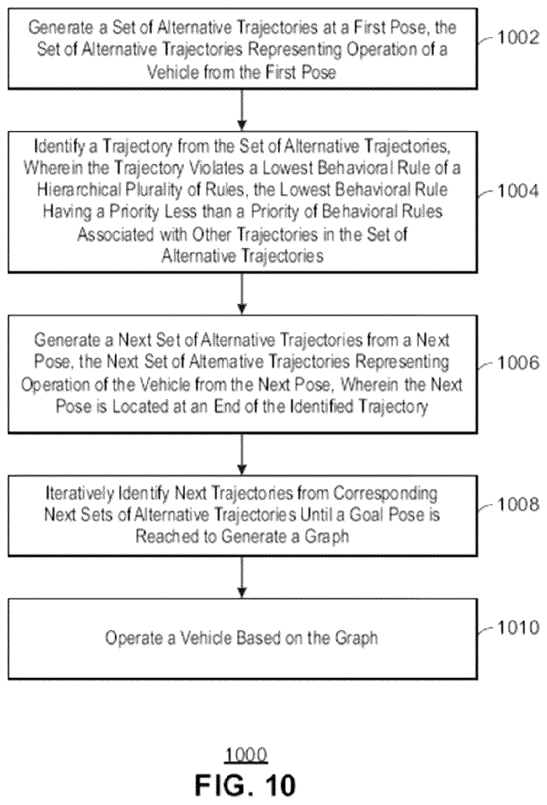

Referring now to FIG. 10, illustrated is a flowchart of a process 1000 for graph exploration for trajectory generation based on a hierarchical plurality of rules. In some embodiments, one or more of the steps described with respect to process 1000 are performed (e.g., completely, partially, and/or the like) by the vehicle 200 of FIG. 2 or the autonomous vehicle compute 400 of FIG. 4. Additionally, or alternatively, in some embodiments one or more steps described with respect to process 1000 are performed (e.g., completely, partially, and/or the like) by another device or group of devices separate from or including autonomous vehicle compute 400 such as device 300 of FIG. 3.

At block 1002, a set of alternative trajectories for a vehicle at a first pose are generated. In some embodiments, the alterative trajectories are sets of trajectories generated using behavior prediction. In some embodiments, the first pose is a root node of the corresponding graph. The set of alternative trajectories represent operation of the vehicle from the first pose.

At block 1004, a trajectory from the set of alternative trajectories is identified. In some embodiments, the trajectory violates a behavioral rule of a hierarchical plurality of rules with a priority less than a priority of behavioral rules violated by other trajectories in the set of alternative trajectories. Accordingly, in some embodiments, the present techniques select the one or more trajectories at the first node that cause a violation of a rule that satisfies (e.g., is below) a threshold priority (e.g., such as a trajectory that causes a violation of a lowest priority rule as compared to violations of other rules by other trajectories).

At block 1006, a next set of alternative trajectories is generated from a next pose at the end of the trajectory responsive to identifying the trajectory. The next set of alternative trajectories represents operation of the vehicle from the next pose. In this manner, the graph is iteratively grown based on the next pose at the end of the identified trajectory. The next set of alternative trajectories for the vehicle may be generated from the next pose by applying vehicle dynamics associated with the next pose to possible trajectories associated with a location of the next pose. Vehicle dynamics include, for example, speed, location, acceleration, and orientation associated with the trajectory at the next pose.

At block 1008, next trajectories from corresponding next sets of alternative trajectories are iteratively identified. In some embodiments, a next trajectory violates a behavioral rule of the hierarchical plurality of rules with a priority less than a priority of behavioral rules violated by other trajectories in a corresponding next set of alternative trajectories until a goal pose is reached to generate a graph. Put another way, in some embodiments, the present techniques iteratively repeat steps of identifying a trajectory from a set of trajectories at a pose at the end of a previously identified trajectory until the goal pose is reached. In some embodiments the trajectory does not reach a goal pose, and the present techniques iteratively repeat steps of identifying a trajectory at the end of a previously identified trajectory until a predetermined timeout occurs. In some examples, the trajectory is the trajectory that causes violation of a rule that satisfies (e.g., is below) a threshold priority (e.g., such as a trajectory that causes a violation of a lowest priority behavioral rule as compared to other trajectories, where the trajectories are ranked according to rule violations in a hierarchical plurality of rules). Growing the graph generally continues until a path to the goal pose from the first pose is identified as described above.

At block 1010, a vehicle is operated based on the graph. In examples, vehicle operation based on the graph includes extracting a path (e.g., one or more trajectories) from the graph and/or combining one or more trajectories in the graph to generate a larger or merged trajectory and then modifying one or more driving parameters of the vehicle (e.g., speed, heading, etc.) to follow the trajectory.

In certain cases, the actual trajectory taken by a vehicle can be compared with the trajectories extracted from the graph. In this manner, performance of the vehicle is evaluated in view of a determined trajectory. For example, the actual trajectory can be evaluated to determine how closely it followed the extracted trajectories from the graph. In this way, the trajectories extracted from the graph can be used to provide feedback on vehicle performance.

It will be understood that the process 1000 may be repeated multiple times per second throughout a route of a vehicle. By repeating the process 1000 multiple time per second and/or throughout the route of the vehicle, the vehicle can generate thousands or millions or more trajectories during the route, evaluate them based on the violation of rules, and select trajectories that can reduce the risk of collision or injury to the passenger and/or others along the route. Moreover, given the nature of autonomous vehicles and the small time window (less than one second) available to generate multiple (e.g., hundreds or thousands or more) trajectories, evaluate the trajectories as described herein, select a trajectory, and navigate the vehicle according to the selected trajectory, it is not feasible possible for a human to perform the functions described herein.

### Trajectory Selection Utilizing Different Criterion

A system can operate a vehicle to move along a route (e.g., from a first location to a second location). As the vehicle moves along the route, the vehicle can encounter a number of objects (e.g., pedestrians, other vehicles, traffic lights, traffic signs, road work, traffic, etc.). In response, the vehicle can generate one or more trajectories or paths around the objects. The systems may generate the trajectories based on criterion (e.g., various functions, objectives, goals, processes, models, sensor data, etc.). For example, the systems generate the trajectories based on cost functions, planner or planning objectives, etc. (e.g., reaching the destination within a particular time).

The system can define a route from a source to a destination based on the trajectory or path. For example, the route can be based on multiple paths or trajectories. However, the generated trajectories or paths can violate one or more rules, such as but not limited to traffic laws, cultural expectations of driving behavior, reaching a destination (e.g., within a particular time period), etc. As discussed above, the rules can be grouped into a hierarchical plurality of rules that defines a priority of all or a portion of the rules.

As all or a portion of the paths can cause a violation of a different rule with a different (e.g., lower) priority or may not cause a violation of rule, the system can select a path that causes a violation of a rule that satisfies (e.g., is below) a threshold priority (e.g., such as a trajectory that causes a violation of a rule with the lowest priority (and does not cause a violation of a rule with a higher priority) as compared to the priorities of the rule violations of the other paths or does not cause violation of a rule). The operation of the vehicle according to a path that causes a violation of a rule that does not satisfy a threshold priority (e.g., a higher priority rule) when a path that causes a violation of a rule that does satisfy a threshold priority (e.g., a lower priority rule (and does not cause a violation of the higher priority rule or a rule with a higher priority as compared to the higher priority rule)) is available can produce adverse effects, such as increasing the likelihood of a collision or causing discomfort to passengers.

To build the path, the system can select a trajectory from a plurality of trajectories in different planning steps (e.g., cycles, intervals, etc.) for the path based on the priority of rules violated by the trajectories of the plurality of trajectories. For example, in a first planning step, the system can select a first trajectory (T1) based on a priority of a rule (P1) violated by the first trajectory compared to a priority of rules (e.g., P2, P3) violated by other trajectories (e.g., T2, T3) from a first set of the plurality of trajectories. In a second planning step, the system can select a second trajectory branched from the first trajectory (e.g., T1.TA) based on a priority of a rule (P4) violated by the second trajectory compared to a priority of rules (e.g., P5, P6) violated by other trajectories (e.g., T1.TB, T1.TC) from a second set of the plurality of trajectories. Accordingly, the system can iteratively select a trajectory in a planning step from a pose located at an end of a trajectory selected in a prior planning step. Therefore, systems can generate a path by iteratively selecting trajectories branched from trajectories selected during previous planning steps. The systems can generate a route by combining one or more paths.

In some cases, to select a trajectory, the systems may generate a plurality of trajectories that includes trajectories for all or a portion of the planning steps and may select trajectories from the generated trajectories. The systems may generate a plurality of trajectories prior to all or a portion of the planning steps based on the environment of the vehicle at a particular period of time. For example, the systems may generate the trajectories for all or a portion of the planning steps based on the presence of a pedestrian on the edge of a road, another vehicle approaching the vehicle, etc. By generating the trajectories prior to all or a portion of the planning steps, the systems may not be limited to generating the trajectories over a particular period of time (e.g., a duration of a planning step) and/or may not be limited to generating a particular number of trajectories.

The generation and selection of trajectories prior to all or a portion of the planning steps, however, may not define a preferred path (e.g., a path with a lower number of violations or an overall lower priority of violations). For instance, while a trajectory selected during a particular planning step for implementation may violate a rule with a lower priority as compared to the priority of other rules violated by other trajectories of the generated plurality of trajectories, because the trajectories are generated prior to the particular planning step, the generated plurality of trajectories may not reflect changes in the environment of the vehicle. For example, a pedestrian may begin or may finish crossing the road, a vehicle may begin or may finish switching lanes, etc. after a first planning step and before a second planning step such that a selected trajectory may cause a violation of higher priority rule as compared to a rule of which the selected trajectory is predicted to cause violation (e.g., at generation and/or selection of the trajectory).

By generating the trajectories prior to all or a portion of the planning steps, all or a portion of the trajectories may cause violation of a rule with a higher priority during a second planning step as compared to a first planning step. For example, during a first planning step, a trajectory may cause violation of a rule with a first priority and, during a second planning step, based on changes to the environment of the vehicle, a trajectory may cause violation of a rule with a second priority which may be greater than the first priority. Therefore, the selected trajectories for a path may not represent a path that causes a violation of a rule that satisfies (e.g., is below) a threshold priority (e.g., such as a trajectory that causes a violation of a rule with the lowest priority).

In some cases, to select a trajectory, the systems may generate trajectories at all or a portion of the planning steps and select a trajectory from the generated trajectories. The systems may generate trajectories de novo in real time at all or a portion of the planning steps to account for changes in the environment of the vehicle. For example, a pedestrian may begin or may finish crossing a road, a vehicle may begin or may finish switching lanes, etc. after a first planning step and before a second planning step. By generating the trajectories at all or a portion of the planning steps, the systems can respond to the changes in the environment (e.g., by braking based on a pedestrian who is beginning to cross the road on which the vehicle is operating).

Because the systems may generate the trajectories de novo in real time, the generated plurality of trajectories may be limited in complexity, quantity, and/or speed of generation. For example, the systems may be limited to generating the plurality of trajectories over a particular period of time (e.g., 100 milliseconds) and/or may be limited to generating a particular number of trajectories (e.g., 3 trajectories) as a result of generating the trajectories de novo and in real time at all or a portion of the planning steps. Additionally, due to the time period utilized for generation of the plurality of trajectories, the plurality of trajectories may not be based on an updated representation of the environment (e.g., the trajectories may be based on a first location of another vehicle and at implementation of a trajectory of the trajectories, the other vehicle may have a second location).

To account for the delay between generation of the plurality of trajectories and the implementation of a corresponding trajectory, the system may predict changes to the environment. For example, based on obtained sensor data, the systems, at particular time steps, the systems may identify a state of the environment (e.g., a pedestrian stepping into the road) and may predict further changes in the environment (e.g., the pedestrian crossing the road). The systems may utilize the predicted changes in the environment to generate the trajectories such that the generated trajectories account for the predicted changes in the environment. For example, the systems may predict that a pedestrian may cross the road and the systems may generate trajectories to avoid the pedestrian crossing the road.

The iterative generation and selection of trajectories at all or a portion of the planning steps, however, may not define a preferred path (e.g., a path with a lower number of violations or an overall lower priority of violations) when implemented by the vehicle in the event that the environment does not change in the predicted manner. For example, the systems may not respond to rapid or unpredicted changes within the environment prior to or during implementation of the trajectory by the vehicle (e.g., occluded objects such as a stopped vehicle located after the vehicle crests a hill, etc.), objects acting in an unexpected manner (e.g., a vehicle switching lanes within a particular proximity of the vehicle (cutting in), a bicycle moving perpendicular to the movement of the vehicle, a vehicle slowing down but not stopping before turning at an intersection, a vehicle accelerating when making an unprotected turn instead of decelerating or turning away, etc.), malicious actors (e.g., malicious actors attempting to cause a rule violation), localization lateral and/or yaw errors, map annotation errors (e.g., errors incorrectly indicating features of the environment), object heading/orientation errors (e.g., errors incorrectly identifying the orientation of an object), incorrectly identified objects (e.g., disappearing objects), etc.

In another example, the systems may not respond to (e.g., predict) nature-specific actions taken by objects that deviate from the predicted actions to be taken by the object (e.g., an aggressive driver causing a vehicle to aggressively switch lanes, a cautious driver causing a vehicle to excessively brake, an inexperienced cyclist causing a bicycle to leave a bicycle lane and enter a road, etc.).

Instead, the trajectories generated by the systems may be based on the environment changing in the predicted manner. For example, vehicles may include systems (e.g., automatic braking systems) that can cause the vehicles to automatically brake based on sensor data. However, such systems may be based on the environment changing in a predicted and/or predictable manner and may not be capable of responding in a rapid manner to unexpected or rapid changes in the environment. For example, such systems may be based on the prediction that a pedestrian crossing the road will continue crossing the road until the pedestrian has crossed the road or that a braking car will continue to brake. If the environment does not change in the predicted manner or changes in a manner different from the predicted manner, such systems may cause a violation of a rule with a different priority (e.g., a higher priority rule) as compared to the rule corresponding to the predicted violation.

Such systems may be limited to identifying objects within a particular distance of a front of the vehicle and causing the vehicle to brake in response to such identification. Such systems may not be aware of other objects in the environment of the vehicle and may not be capable of implementing other vehicle actions (e.g., turning). For example, such systems may be limited to implementing automatic braking based on a limited subset of available sensor data and may not be capable of utilizing swerving trajectories (e.g., turning left, turning right, etc.) in response to obtained sensor data and/or may not be capable of utilizing sensor data that does not correspond to a location immediately in front of the vehicle. Such systems may be inefficient and may result in an undesirable user experience as the selected trajectories for a path may not represent a path that causes a violation of a rule that satisfies (e.g., is below) a threshold priority (e.g., such as a trajectory that causes a violation of a rule with the lowest priority as compared to other rule violations).

To address these issues, the planning system 404 can generate a plurality of trajectories (e.g., prior to all or a portion of the planning steps) based on sensor data associated with one or more sensors of a vehicle. To generate the plurality of trajectories, the planning system 404 may generate a first subset of trajectories (e.g., a first trajectory) using a first set of criterion and a second subset of trajectories (e.g., a second trajectory) using a second set of criterion. The second subset of trajectories may be trajectories based on defensive or evasive driving maneuvers (e.g., swerving, braking, acceleration, etc.)

The first subset of trajectories may be longer term trajectories (as compared to the second subset of trajectories) and the second subset of trajectories may be shorter term trajectories (as compared to the first subset of trajectories). For example, the longer term trajectories may be based on a longer horizon as compared to the shorter term trajectories (e.g., 8 seconds as compared to 3 seconds), a greater latency as compared to the shorter term trajectories (e.g., 200-750 milliseconds as compared to 50 milliseconds), and/or different criterion. In some cases, the first subset of trajectories include a planned trajectory path that is longer in duration (e.g., temporal duration) than the planned trajectory path of the second subset of trajectories. In certain cases, the duration of the planned trajectory path of the second subset of trajectories is less than half of the duration of the planned trajectory path of the first subset of trajectories.

The first subset of trajectories and the second subset of trajectories may be generated based on different criterion (e.g., different sensor data, different objectives, different functions, different processes, different goals, different models, etc.) and/or may provide different weights or prioritizations (e.g., indicative of a weight of the criterion relative to other criterion during generation of the trajectories) for the different criterion. For example, the planning system 404 may weight a first objective with a first weight to generate the first subset of trajectories and may weight the first objective with a second weight to generate the second subset of trajectories.

The criterion may include functions (e.g., example functions may include cost functions to determine (and improve) performance of a trajectory generator, functions to generate trajectories, etc.), goals (e.g., example goals may include reaching the destination, ensuring safety of a passenger of the objective, avoiding a violation of a rule of the hierarchical plurality of rules, ensuring comfort of a passenger, etc.), objectives (e.g., example objectives may include planner or planning objectives indicating operation of a trajectory generator), models (e.g., example models may include machine learning models), processes (e.g., example processes may include planning processes), sensor data, etc. For example, the planning system 404 can generate the first subset of trajectories based on first sensor data associated with the one or more sensors of the vehicle (e.g., a lidar sensor, an image sensor, a radar sensor, etc.) and the second subset of trajectories based on second sensor data associated with the one or more sensors.

The criterion utilized to generate the first subset of trajectories may be or may include general criterion (e.g., default criterion to avoid approaching within a particular distance of another vehicle, to maintain a speed below a particular threshold, etc.), location-oriented criterion (e.g., criterion that are specific to, particular to, and/or based on location of the vehicle such as criterion to avoid pulling off on a highway where construction is occurring, to avoid braking rapidly when descending via a steep decline, etc.), comfort-oriented criterion (e.g., criterion that are based on a comfort of a passenger of the vehicle such as criterion to avoid jostling a passenger, to avoid sudden stops, etc.), destination-oriented criterion (e.g., criterion that are specific to, particular to, and/or based on a destination of the vehicle such as criterion to reach a particular destination by a particular time), safety-oriented criterion (e.g., collision avoidance and/or maintaining a threshold distance from other objects), etc. whereas the criterion utilized to generate the second subset of trajectories may be or may include (only) safety-oriented criterion or prioritize safety-oriented criterion more than some or all other criterion. For example, the general criterion, location-oriented criterion, comfort-oriented criterion, destination-oriented criterion, safety-oriented criterion, etc. may be weighted with a first set of weights to generate the first subset of trajectories while the general criterion, location-oriented criterion, comfort-oriented criterion, destination-oriented criterion, safety-oriented criterion, etc. may be weighted with a second weight (that prioritizes the safety-oriented criterion more as compared to the first weight) to generate the second subset of trajectories.

The second subset of trajectories may be based on a subset of the criterion on which the first subset of trajectories is based (e.g., the safety-oriented criterion) or different criterion as compared to the criterion on which the first subset of trajectories is based. For example, the first subset of trajectories may be based on destination objectives (e.g., reaching a destination by a particular time) and the second subset of trajectories may not be based on destination objectives and/or may weigh the destination objectives less as compared to the first subset of trajectories. In some cases, the planning system 404 may generate the first subset of trajectories using more criterion (e.g., more computationally intensive criterion, numerically more criterion, etc.) as compared to the criterion utilized for generation of the second subset of trajectories. Moreover, as the sensor data used to detect a potential collision (or other safety-oriented criterion) may be less than the sensor data used to generate first subset of trajectories, the planning system 404 may use less data and less compute resources to generate the second subset of trajectories in less time (as compared to amount of data, compute resources, and time to generate the first subset of trajectories).

Additionally, based on generating the first subset of trajectories and the second subset of trajectories based on different criterion, the planning system 404 may generate the first subset of trajectories and the second subset of trajectories at different frequencies and with different latencies. For example, the planning system 404 may generate the first subset of trajectories at a first frequency (e.g., every 500 ms) and with a first latency (e.g., 100 ms) and may generate the second subset of trajectories at a second frequency (e.g., every 50 ms) that is greater than the first frequency and with a second latency (e.g., 10 ms) that is less than the first latency.

The planning system 404 may use multiple trajectory generators (e.g., planners) to generate the plurality of trajectories. For example, the multiple trajectory generators may correspond to separate and/or different compute modules, software modules, etc. In some cases, the planning system 404 may use a single trajectory generator to generate the plurality of trajectories (e.g., a partitioned trajectory generator, a layered trajectory generator, etc.). For example, the planning system 404 may include a hybrid trajectory generator, a dual trajectory generator, etc.

In some cases, the planning system 404 may include a first trajectory generator to generate a first subset of trajectories and a second trajectory generator (e.g., a reflexive trajectory generator) to generate a second subset of trajectories. In some cases, the planning system 404 may (e.g., concurrently or simultaneously) provide sensor data associated with at least one sensor of a vehicle and/or location data associated with the vehicle to the first trajectory generator and the second trajectory generator. For example, the planning system 404 may provide the same or different sensor data associated with the at least one sensor and/or the location data to the first trajectory generator or the second trajectory generator.

The first trajectory generator may be a more computationally intensive trajectory generator as compared to the second trajectory generator. For example, the first trajectory generator may use more sensor data, generate more or more complex trajectories, use more processing or compute resources (e.g., more processor cores and/or memory), execute more functions, and/or may have longer compute times (e.g., 200 ms to 750 ms) as compared to the sensor data used by, trajectories generated by, processing or compute resources used by, the functions executed by, and/or the compute time of the second trajectory generator (e.g., 35 ms to 100 ms).

Additionally, the first trajectory generator may consider a greater time horizon (e.g., a length of time in which to plan ahead) in generating trajectories as compared to the time horizon considered by the second trajectory generator. As a non-limiting example, the first trajectory generator may generate trajectories over a time horizon of 6-8 seconds (secs) and the second trajectory generator may generate trajectories over a time horizon of three seconds or less.

Further, the first trajectory generator may utilize a larger amount of sensor data and/or different sensor data to generate the first subset of trajectories as compared to the sensor data utilized by the second trajectory generator to generate the second subset of trajectories. For example, the first trajectory generator may utilize sensor data obtained at or captured over a first time period to generate trajectories at a particular time and the second trajectory generator may utilize sensor data obtained at or captured over a second time period different from the first time period to generate trajectories at the particular time. The second trajectory generator may generate a second subset of trajectories using sensor data that is updated, more up to date, etc. as compared to the sensor data used to generate the first subset of trajectories (e.g., the sensor data used to generate the first subset of trajectories may be outdated when the second subset of trajectories are generated). For example, given the lag in generating the first subset of trajectories, the first trajectory generator may output one or more trajectories at time t=1 based on sensor data that was received 250-750 ms prior, whereas the second trajectory generator may output one or more trajectories at time t=1 based on data received 10-50 ms prior.

As the second trajectory generator may utilize updated (or more recent) sensor data compared to the sensor data utilized by the first trajectory generator and utilize or prioritize safety-oriented criterion to generate the trajectories (e.g., prioritize the safety-oriented criterion and/or not consider non-safety-oriented criterion), the second trajectory generator may provide safer trajectories as compared to the trajectories provided by the first trajectory generator. For example, a pedestrian may move into a road after the first sensor data that is to be used by the first trajectory generator is obtained and subsequent to the second sensor data that is to be used by the second trajectory generator is obtained. Therefore, the second trajectory generator may account for the presence of the pedestrian in the road while the first trajectory generator may not account for the presence of the pedestrian.

Further, by using the second sensor data as compared to the first sensor data and by considering the safety-oriented criterion (instead of or prioritized over the non-safety-oriented criterion), the second trajectory generator may be able to identify trajectories that are safer in the short term as compared to the trajectories generated by the first trajectory generator. In this manner, the second trajectory generator can validate the safety (e.g., the short term safety) of a trajectory generated by the first trajectory generator, and/or can provide a trajectory to be used in place of the trajectory generated by the first trajectory generator.

Moreover, as the second sensor data (or data used to detect a potential collision or other safety-oriented criterion) may be or may include less sensor data than the sensor data used to generate first subset of trajectories (e.g., with longer time horizons and/or with more criterion), the second trajectory generator 1110B may use less data and less compute resources to generate the second subset of trajectories in less time (as compared to amount of data, compute resources, and time to generate the first subset of trajectories).

Therefore, the first trajectory generator may generate trajectories that satisfy a plurality of longer term criterion (e.g., reach a destination, avoid all or a portion of potential rule violations, provide for passenger comfort, provide for passenger safety, etc.) while the second trajectory generator may generate trajectories that satisfy a particular short term criterion (e.g., avoid a particular safety-oriented rule violation). However, as the longer term criterion may include numerically more criterion and/or more computationally intensive criterion as compared to the short term criterion, the first trajectory generator may require longer compute times as compared to the second trajectory generator. Accordingly, the planning system 404 may identify how and when to switch from trajectories generated by the first trajectory generator to trajectories generated by the second trajectory generator.

As discussed above, the first trajectory generator may generate the first subset of trajectories for all or a portion of the planning steps. Further, the second trajectory generator may generate the second subset of trajectories for all or a portion of the planning steps. In some cases, the first trajectory generator and the second trajectory generator may operate simultaneously such that the first trajectory generator and the second trajectory generator simultaneously generate trajectories. For example, the first trajectory generator and the second trajectory generator can operate in parallel for generation of trajectories.

In some cases, the first trajectory generator may generate the first subset of trajectories for each of the planning steps and the second trajectory generator may generate the second subset of trajectories based on (e.g., in response to) generation of the first subset of trajectories by the first trajectory generator and/or obtaining updated (more recent) sensor data. For example, the second trajectory generator may determine that the first trajectory generator generated the first subset of trajectories and, in response to determining that the first trajectory generator generated the first subset of trajectories, may generate the second subset of trajectories and/or the second trajectory generator may obtain sensor data (e.g., updated or more sensor data) and, in response to obtaining the sensor data, may generate the second subset of trajectories. Accordingly, the second trajectory generator may generate multiple second subsets of trajectories for all or a portion of the planning steps.

The first trajectory generator and/or the second trajectory generator may generate respective subsets of trajectories based on sensor data and/or location data associated with the vehicle and provide the respective subsets of trajectories to a selector for selection of a trajectory. In some cases, the first trajectory generator and/or the second trajectory generator may each select a single trajectory from their respective subsets of trajectories and provide the respective single trajectory to the selector, such that the selector receives a trajectory from the first subset of trajectories and a trajectory from the second subset of trajectories. In some cases, the first and/or second trajectory generator may be used to select a trajectory from each of the subset of trajectories. In certain cases, the first trajectory generator and the second trajectory generator may send some or all of their respective subsets of trajectories to the selector and the selector may select a trajectory from the multiple subsets of trajectories.

The selector may obtain sensor data associated with the vehicle. For example, the selector may obtain the (same) sensor data utilized by the second trajectory generator to generate the second subset of trajectories. As described herein, the sensor data may be updated or more recent sensor data relative to the sensor data used by the first trajectory generator to generate the first subset of trajectories and/or to select a trajectory from the first subset of trajectories. As the sensor data may be updated sensor data relative to the sensor data used by the first trajectory generator, the selector may use the sensor data to verify whether the environment of the vehicle has changed such that the first subset of trajectories (e.g., the selected trajectory) is predicted to cause a violation of a particular rule (e.g., different from an original prediction used to select the trajectory), such as cause a collision or come within a threshold distance of an object or agent.

In some cases, the selector may determine rule violation data based on the sensor data. For example, the rule violation data may include a likelihood (e.g., probability) of a rule violation by the vehicle and/or a distance from a rule violation by the vehicle.

The selector may obtain threshold data indicative of one or more thresholds (e.g., threshold values, threshold ranges, etc.) associated with the sensor data and/or the rule violation data. For example, the one or more thresholds may indicate a threshold likelihood of a rule violation, a threshold distance (e.g., physically, temporally, etc.) from a rule violation, etc.

The selector may analyze the rule violation data using the one or more thresholds. For example, the selector may analyze the rule violation data to determine if a likelihood of a rule violation is greater than, matches, is less than, or is within a threshold likelihood of a rule violation and/or if the vehicle is less than, matches, is greater than, or is within a threshold distance (e.g., physically, temporally, etc.) from a rule violation. Based on analyzing the sensor data, the selector may select a trajectory from the first subset of trajectories or a trajectory from the second subset of trajectories.

The selector can select a shorter term trajectory (e.g., braking, swerving, etc.) based on the rule violation data indicating that a likelihood of a rule violation satisfies a rule violation threshold (e.g., is greater than, matches, or is within a threshold likelihood of a rule violation or that the vehicle is less than, matches, or is within a threshold distance from a rule violation). The selector can select a longer term trajectory based on the rule violation data indicating that a likelihood of a rule violation does not satisfy a rule violation threshold (e.g., is less than a threshold likelihood of a rule violation and/or that the vehicle is greater than a threshold distance from a rule violation). By selecting a trajectory in such a manner, the planning system 404 can increase the safety and reliability of the system as compared to some systems that select trajectories from trajectories generated based on the same criterion.

The planning system 404 can iteratively repeat the process of generating a first subset and a second subset of trajectories and selecting trajectories from the generated first subset and second subset of trajectories for all or a portion of the planning steps. Based on the selected trajectories, the planning system 404 can define a path for the vehicle. The path can define a portion of a route for the vehicle from a first pose to a second pose (a first trajectory) to a third pose (a second trajectory) to a fourth pose (a third trajectory) ... to a final pose (a final trajectory). In some cases, the planning system 404 can iteratively select a trajectory and instruct navigation according to the selected trajectory (e.g., based on sending the selected trajectory to a controller of the vehicle) prior to selecting a subsequent trajectory. Accordingly, the planning system 404 can generate a path that includes a trajectory from the first subset of trajectories or the second subset of trajectories at each planning step.

In some cases, the planning system 404 can define a route from a source to a destination based on the path. For example, the route can be based on multiple paths or trajectories.

In certain cases, the planning system 404 may utilize the path to train and/or test a control system of a vehicle. In some cases, the planning system 404 may provide a scene to a control system of a vehicle (e.g., in real time) and verify whether the vehicle navigates the scene according to the path.

It will be understood that this process may be repeated multiple times per second throughout a route of a vehicle. By repeating the process multiple time per second and/or throughout the route of the vehicle, the vehicle can generate thousands or millions or more trajectories during the route, evaluate them based on the violation of rules, and select trajectories that can reduce the risk of collision or injury to the passenger and/or others along the route. Moreover, given the nature of autonomous vehicles and the small time window (less than one second) available to generate multiple (e.g., hundreds or thousands or more) trajectories, evaluate the trajectories as described herein, select a trajectory, and navigate the vehicle according to the selected trajectory, it is not feasible possible for a human to perform the functions described herein.

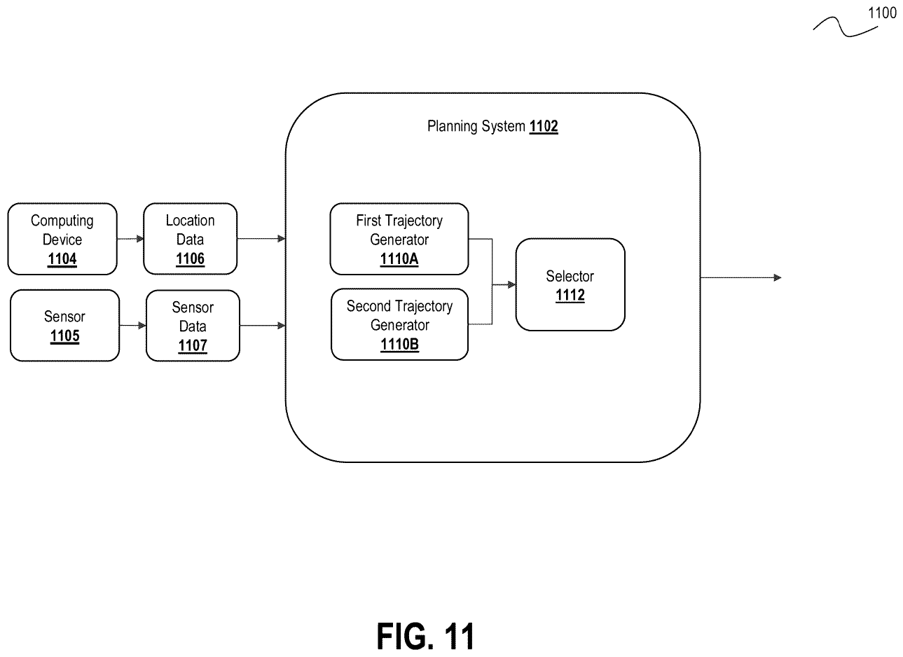

FIG. 11 is a block diagram illustrating an example of a planning environment 1100. In the illustrated example, the planning environment 1100 includes a planning system 1102 communicatively coupled with a computing device 1104 and a sensor 1105. The computing device 1104 can be the same as or similar to device 300 as described in FIG. 3. In some cases, the planning environment 1100 and/or the planning system 1102 can form at least a part of the planning system 404, described herein at least with reference to FIG. 4. In some cases, the planning system 1102 may be and/or may include a signal processing system and/or may include one or more signal processors. The planning system 1102 can receive location data 1106 associated with the computing device 1104 and use the location data 1106 and sensor data to identify a path for a vehicle.

The planning system 1102 (or another computing system) can initialize a path generation process. For example, the planning system 1102 (or a separate system) can receive a request from a computing device (e.g., a user computing device) to navigate to a particular destination. In response, the planning system 1102 can initialize a path generation process to generate a path from a first pose to a second pose. In some cases, the planning system 1102 can generate a route for the vehicle from a source (e.g., a location of the vehicle) to the destination for the vehicle based on one or more paths. In another example, the planning system 1102 (or a separate system) can receive a request to train or test a control system of the vehicle and, in response, initialize the path generation process.

The computing device 1104 provides location data 1106 associated with a location of a vehicle to the planning system 1102. In some cases, the planning system 1102 causes the computing device 1104 to provide the location data 1106 based on the initialization of the path generation process.

The computing device 1104 may be a computing device for generating training data (e.g., training location data that represents the location of a vehicle (physical or simulated) having an autonomous system installed thereon) and may provide the training data to the planning system 1102 to train and/or test a control system of a vehicle.

In some cases, the computing device 1104 may be omitted, may form at least part of the localization system 406, and/or be in communication with a sensor. For example, the computing device 1104 may be in communication with (e.g., receive sensor data from) a location sensor (e.g., a global positioning sensor) associated with (e.g., located in, affixed to, etc.) a vehicle as part of the localization system 406. In some embodiments, the computing device 1104 may be in communication with a plurality of sensors (e.g., a plurality of different location sensors) that each generate and/or provide location data to the planning system 1102. Similarly, the location data 1106 can include different types of location data, such as global positioning data associated with a vehicle. In some cases the computing device 1104 generates location data 1106 based on one or more settings (e.g., a time period). For example, the one or more settings may identify a time period for detection of the location data 1106. The location data 1106 may include streaming data and/or batch data.

The sensor 1105 may be a sensor associated with the vehicle and may provide sensor data 1107 to the planning system 1102. For example, the sensor 1105 may be a lidar sensor associated with (e.g., located in, affixed to, etc.) a vehicle, an image sensor associated with the vehicle, a radar sensor associated with the vehicle, a timer, etc. In some embodiments, the planning system 1102 may be in communication with a plurality of sensors (e.g., a plurality of different sensors) that each generate and/or provide sensor data to the planning system 1102. Similarly, the sensor data 1107 can include different types of component data, such as lidar data associated with the vehicle, image data associated with the vehicle, time data associated with the vehicle, etc. The sensor data 1107 may include streaming data and/or batch data.

In some cases, the sensor data 1107 may correspond to data received from the perception system 402. In some such cases, the sensor data 1107 may include semantic data corresponding to one or more semantic images generated by the perception system 402 and/or feature data corresponding to features extracted from sensor data received by the perception system 402. For example, the feature data may include feature extractions from various sensors, such as cameras 202a, LiDAR sensors 202b, radar sensors 202c, and microphones 202d.

The planning system 1102 may include a plurality of processors to receive the location data 1106 and/or the sensor data 1107. The planning system 1102 can process the location data 1106 and the sensor data 1107 to generate path data corresponding to a navigable path for the vehicle. In some cases, the planning system 1102 processes the location data 1106 and the sensor data 1107 to generate path instructions for a control system of a vehicle.

The planning system 1102 may implement two or more trajectory generators using the plurality of processors. For example, the planning system 1102 may implement a first trajectory generator using at least one first processor and a second trajectory generator using at least one second processor. In the example of FIG. 11, the planning system 1102 includes a first trajectory generator 1110A and a second trajectory generator 1110B, however, it will be understood that the planning system 1102 may include fewer or more trajectory generators 1110. The first trajectory generator 1110A and the second trajectory generator 1110B may be the same or different trajectory generators and may utilize different criterion (e.g., different functions, objectives, goals, processes, models, sensor data, etc.). For example, the first trajectory generator 1110A and/or the second trajectory generator 1110B may execute a monte carlo tree search, imitation learning, a learned scoring function, a handcrafted scoring function, or other machine learning model to generate trajectories, etc. In some cases, the first trajectory generator 1110A and/or the second trajectory generator 1110B may be implemented as a machine learning model (e.g., a neural network). For example, the first trajectory generator 1110A and/or the second trajectory generator 1110B may be a recurrent neural network where a hidden state of the recurrent neural network is preserved across planning steps.

The planning system 1102 may utilize the two or more trajectory generators to generate the path data. Specifically, the planning system 1102 may use the first trajectory generator 1110A to generate a first subset of trajectories and may use the second trajectory generator 1110B to generate a second subset of trajectories and may select a trajectory from the first subset and second subset of trajectories.

The first trajectory generator 1110A and the second trajectory generator 1110B may generate respective subsets of trajectories based on different criterion. The first trajectory generator 1110A and the second trajectory generator 1110B may generate trajectories based on different priorities, considerations, etc. For example, the first trajectory generator 1110A may generate trajectories based on a higher priority to reach a subsequent pose as compared to trajectories generated by the second trajectory generator 1110B. Further, in some cases, the first trajectory generator 1110A may consider comfort of a passenger and safety of a passenger in generating trajectories while the second trajectory generator 1110B may not consider comfort of the passenger and may prioritize safety of the passenger in generating trajectories.

The first trajectory generator 1110A may generate the first subset of trajectories based on a first set of criterion (e.g., functions, objectives, goals, processes, models, sensor data, etc.), and the second trajectory generator 1110B may generate the first subset of trajectories based on a second set of criterion (e.g., functions, objectives, goals, processes, models, sensor data, etc.) that is different from the first set of criterion. For example, the first trajectory generator 1110A may generate the first subset of trajectories based on a first set of sensor data and the second trajectory generator 1110B may generate the second subset of trajectories based on a second set of sensor data different from the first set of sensor data. In some cases, the first trajectory generator 1110A and the second trajectory generator 1110B may generate respective subsets of trajectories based on the same set of sensor data. In another example, the first subset of trajectories may include trajectories based on a first cost function and a first planning objective while the second subset of trajectories may include trajectories based on a second cost function and a second planning objective that are different form the first cost function and first planning objective, respectively.

Based on the first trajectory generator 1110A and the second trajectory generator 1110B generating subsets of trajectories based on different criterion, the first subset of trajectories and the second subset of trajectories may include different trajectories. The first subset of trajectories generated by the first trajectory generator 1110A may include longer term trajectories based on or prioritizing various long term criterion (e.g., destination based criterion, comfort based criterion, safety based criterion, etc.) and the second subset of trajectories generated by the second trajectory generator 1110B may include shorter term trajectories based on or prioritizing various short term criterion (e.g., safety based criterion) as compared to the various long term criterion. In certain cases, while the shorter term trajectories and the longer term trajectories may be of similar length and/or correspond to similar time periods, the shorter term trajectories and the longer term trajectories may be different based on the respective criterion used to generate the shorter term trajectories and the longer term trajectories. For example, based on the differences between the long term criterion and the short term criterion, the longer term trajectories may be based on a longer time horizon as compared to the shorter term trajectories (e.g., 6-8 seconds as compared to 3 seconds or less), a greater latency as compared to the shorter term trajectories (e.g., 200 750 milliseconds as compared to 50 milliseconds), etc. In another example, the long term criterion may include a goal to reach a destination by a particular time, utilization of sensor data associated with a particular time horizon (e.g., 9 seconds), prioritization of long term safety and comfort of a passenger (e.g., safety and comfort over a duration of a trip), etc. and the shorter term criterion may include utilization of sensor data associated with a particular time horizon (e.g., 4 seconds) that is shorter as compared to the long term criterion, prioritization of short term safety of the passenger (e.g., safety over the next 4 seconds), etc.

The number of criterion of the first set of criterion may be greater than the number of criterion of the second set of criterion. Additionally, the computational requirements associated with the first set of criterion may be greater than the computational requirements associated with the second set of criterion. As the first set of criterion may include more criterion and/or more computationally intensive criterion than the second set of criterion, while the first set of trajectories may result in a better/more comfortable passenger experience (e.g., reaching a destination or subsequent pose by a particular time, passenger comfort, etc.) as compared to the second set of trajectories (absent rapid changes in the environment), the second set of trajectories may enable the planning system 1102 to react to changes in the environment (e.g., detect potential collisions and minimize severity and/or probability of the potential collisions) in a more rapid manner as compared to the first set of trajectories. Therefore, it may be advantageous to utilize both the first set of trajectories and the second set of trajectories and select a particular trajectory from the first set of trajectories and the second set of trajectories based on the environment of the vehicle.

In some cases, the first subset of trajectories may be trajectories between a first pose and a second set of poses and the second subset of trajectories may be trajectories between the first pose and a third set of poses.

Based on the location data 1106 (e.g., indicative of a location of the vehicle) and the sensor data 1107, the planning system 1102 can determine (e.g., generate) a first subset and a second subset of trajectories. In some cases, the planning system 1102 may generate the first subset and the second subset of trajectories based on route data indicative of a route for a vehicle (e.g., indicative of a source and destination). The planning system 1102 may determine a first subset of trajectories and a second subset of trajectories for each planning step of a plurality of planning steps. For example, the planning system 1102 may determine a respective first subset of trajectories and a respective second subset of trajectories between a first pose and a second set of poses, a respective first subset of trajectories and a respective second subset of trajectories between the second set of poses and a third set of poses, ..., a respective first subset of trajectories and a respective second subset of trajectories between a nth set of poses and an xth pose.

In some cases, the planning system 1102 may determine a respective first subset of trajectories for some or all planning steps and may determine the second subset of trajectories for all or a portion of the planning steps. For example, the second subset of trajectories may be general trajectories (e.g., general swerving trajectories, general braking trajectories, etc.) that are utilized (e.g., available for selection) in all or a portion of the planning steps. In another example, the planning system 1102 may select a same braking trajectory for a first planning step and a fifth planning step.

The planning system 1102 may use the first trajectory generator 1110A and the second trajectory generator 1110B to determine the first subset and the second subset of trajectories respectively. The first trajectory generator 1110A and/or the second trajectory generator 1110B may determine a respective subset of trajectories by building a tree of potential trajectories. For example, the first trajectory generator 1110A may perform a stochastic search to identify a respective subset of trajectories.

In some cases, all or a portion of the subsets of trajectories may include a single trajectory. For example, the planning system 1102 may select a single trajectory as the first subset of trajectories. In some cases, all or a portion of the subsets of trajectories may include a primary trajectory (e.g., selected by the planning system 1102 and/or respective trajectory generator) and/or one or more alternative trajectories for the particular planning step. For example, the first subset of trajectories may include a primary trajectory selected by the planning system 1102 and one or more alternative trajectories selected by the planning system 1102. In some cases, all or a portion of the subsets of trajectories may include a set of scored or ranked trajectories. For example, the planning system 1102 may score or rank each of the first subset of trajectories (e.g., a first trajectory may be ranked first, a second trajectory may be ranked second, a third trajectory may be ranked third, etc.) to indicate a selection of a trajectory and alternative trajectories (e.g., a trajectory ranked first may be a selected trajectory and a trajectory ranked second may be a first alternative trajectory). Each trajectory can be ranked and/or scored based on the one or more criterion, such as comfort level, a priority of a rule violation, the number of rule violations, the type of rule violations, the magnitude of rule violations, etc.

For a planning step, the first trajectory generator 1110A may generate and/or provide a respective first subset of trajectories to the selector 1112 (which may include one or more trajectories). Similarly, the second trajectory generator 1110B may generate and/or provide a respective second subset of trajectories (which may include one or more trajectories) to the selector 1112. For example, the first trajectory generator 1110A can provide a first trajectory (selected by the planning system 1102 and/or the first trajectory generator 1110A) to the selector 1112 and the second trajectory generator 1110B can provide a second trajectory (selected by the planning system 1102 and/or the second trajectory generator 1110B) to the selector 1112.

Based on receiving the respective first subset of trajectories and the respective second subset of trajectories, the selector 1112 can select a particular trajectory (e.g., for the vehicle) from the combination of the first subset of trajectories and the second subset of trajectories. For example, the selector 1112 can select a first trajectory from the first subset of trajectories or a second trajectory from the second subset of trajectories for use in controlling the vehicle.

To select the trajectory, the selector 1112 can determine rule violation data. For example, the rule violation data may indicate a likelihood of and/or a distance (e.g., a physical distance, a temporal distance, etc.) from a violation of a rule of a hierarchical plurality of rules by the vehicle. For example, a hierarchical plurality of rules (e.g., a rulebook) can include the following rules, in increasing order of priority: 1: maintain a predetermined speed limit; 2: stay in lane; 3: maintain a predetermined clearance; 4: reach goal; 5: avoid collisions. The rule violation data may indicate a likelihood of and/or a distance from a violation of a particular rule (e.g., a collision with another vehicle).

In some cases, the rule violation data may be based on implementation of a trajectory of the first subset of trajectories. For example, the rule violation data may indicate a likelihood of and/or a distance from a violation of a particular rule (e.g., a collision with another vehicle) based on implementation of the trajectory of the first subset of trajectories (e.g., a trajectory selected from the first subset of trajectories). In some cases, the rule violation data may be based on a current state of the vehicle (e.g., a position of the vehicle). For example, the rule violation data may indicate a likelihood of and/or a distance from a violation of a particular rule (e.g., a collision with another vehicle) based on maintaining a current speed, acceleration, location, etc. of the vehicle.

The selector 1112 can analyze the rule violation data utilizing threshold data (e.g., thresholds, threshold values, threshold ranges, etc.). For example, the selector 1112 can analyze the rule violation data utilizing the threshold data to determine if the rule violation data is greater than, matches, is less than, or is within the thresholds indicated by the threshold data. Based on analyzing the rule violation data, the selector 1112 can select a trajectory from the first subset of trajectories or the second subset of trajectories. For example, the selector 1112 may select a trajectory from the first subset of trajectories based on determining the rule violation data is less than a threshold and may select a trajectory from the second subset of trajectories based on determining the rule violation data matches or is greater than the threshold.

In some cases, to select the trajectory, the selector 1112 may select the first subset of trajectories or the second subset of trajectories and, based on the selection of a particular subset of trajectories, may select a trajectory from the selected subset of trajectories. For example, the selector 1112 may select the first subset of trajectories and may select a highest ranked trajectory as compared to other trajectories of the first subset of trajectories and as ranked by the planning system 1102.

Based on selection of the trajectory, the planning system 1102 may identify path data indicative of a path for the vehicle based on the set of trajectories. For example, the planning system 1102 may identify path data based on a trajectory selected by the selector 1112.

Based on generating the path data, the planning system 1102 can determine that the path data should be routed to a data destination (e.g., a data destination within or separate from the planning system 1102). For example, the planning system 1102 can determine that the path data should be routed to a data store (e.g., within the planning system 1102), a display, a computing device, a computing system, a control system, a plurality of controllers, etc., such as the control system 408 In some cases, the planning system 1102 can determine that the control system 408 of a vehicle should be tested or trained using the path data. In some cases, the planning system 1102 can determine that the control system of a vehicle should be instructed to cause navigation of the vehicle according to the path data. Accordingly, the planning system 1102 can provide the path data to the data destination (e.g., via a gateway such as a controller area network (CAN) gateway).

In some cases, the planning system 1102 (or control system 408) can generate a third subset of trajectories. The third subset of trajectories may include automatic braking trajectories and a vehicle implementing the third subset of trajectories may implement rapid automatic braking. The planning system 1102 (or control system 408) can generate the third subset of trajectories using a third set of criterion that is different from the first set of criterion and/or the second set of criterion. In some cases, the third set of criterion may be based on the distance from the vehicle to another object (e.g., a vehicle, a pedestrian, etc.). In some cases, the third subset of trajectories may not be trajectories in the sense that they do not involve multiple actions (left/right movement, acceleration/deceleration, etc.) or the control of multiple components of the vehicle (e.g., steering wheel control, accelerator control, braking control). In some such cases, the third subset of trajectories may be more accurately referred to as an action or emergency action rather than a trajectory for vehicle navigation.

The third set of criterion may indicate an action that includes more rapid braking if the other object is closer to the vehicle (e.g., 5 meters from the vehicle) as compared to a trajectory where the other object is further from the vehicle (e.g., 10 meters from the vehicle).

In some cases, the third subset of trajectories, actions, or emergency actions may be the same for each planning step. For example, the third subset of trajectories may include the same rapid automatic braking regardless of the planning step whereas the second subset of trajectories may include different trajectories for all or a portion of the planning steps based on the criterion used to generate the third subset of trajectories and the second subset of trajectories.

In some cases, the planning system 1102 can select the trajectory from the first subset of trajectories, the second subset of trajectories, and the third subset of trajectories. For example, the planning system 1102 may select a trajectory from the first subset of trajectories if a likelihood of and/or a distance from a violation of a particular rule (e.g., a collision with another vehicle) does not satisfy a first threshold and a second threshold (that is greater than the first threshold), the planning system 1102 may select a trajectory from the second subset of trajectories if a likelihood of and/or a distance from a violation of a particular rule (e.g., a collision with another vehicle) satisfies a first threshold and does not satisfy a second threshold, and the planning system 1102 may select a trajectory from the third subset of trajectories if a likelihood of and/or a distance from a violation of a particular rule (e.g., a collision with another vehicle) satisfies a first threshold and a second threshold. In some cases, the planning system 1102 can provide the path data and the second subset of trajectories and/or the third subset of trajectories to the data destination (e.g., a first controller and a second controller of a control system). For example, the planning system 1102 may provide the path data, a trajectory from the second subset of trajectories, and/or a trajectory from the third subset of trajectories to the data destination.

As discussed above, the planning system 1102 can provide the path data, the second subset of trajectories, and/or the third subset of trajectories to the control system. Based on receiving the path data and the second subset of trajectories, the control system may select the trajectory indicated by the path data or a trajectory from the second subset of trajectories or the third subset of trajectories. The control system may analyze a state of the vehicle (e.g., a state of a computer of the vehicle) and may select a trajectory based on the state of the vehicle. For example, the control system may select the previously selected trajectory based on determining that a computing device of the vehicle (e.g., an electronic control unit, control modules, etc.) is working and may select a trajectory from the second subset of trajectories or the third subset of trajectories based on determining that the computing device of the vehicle is not powered (e.g., is dead), is not working, etc.

In certain cases, the third subset of trajectories, actions, or emergency actions may be generated by a collision avoidance or emergency braking (AEB) system of the control system 408. For example, the control system may include a collision avoidance system or AEB system that activates brakes when a sensor (e.g., radar sensor, lidar sensor, pressure sensor) detects a collision or an imminent collision (e.g., in less than one second or less than two seconds). In some such cases, the control system 408 may receive the selected trajectory from the planning system 1102 and implement the selected trajectory unless or until it receives an indication from the collision avoidance or AEB system that emergency braking is to be activated (e.g., to avoid or reduce the impact of a collision).

### Example Trajectories for a Vehicle

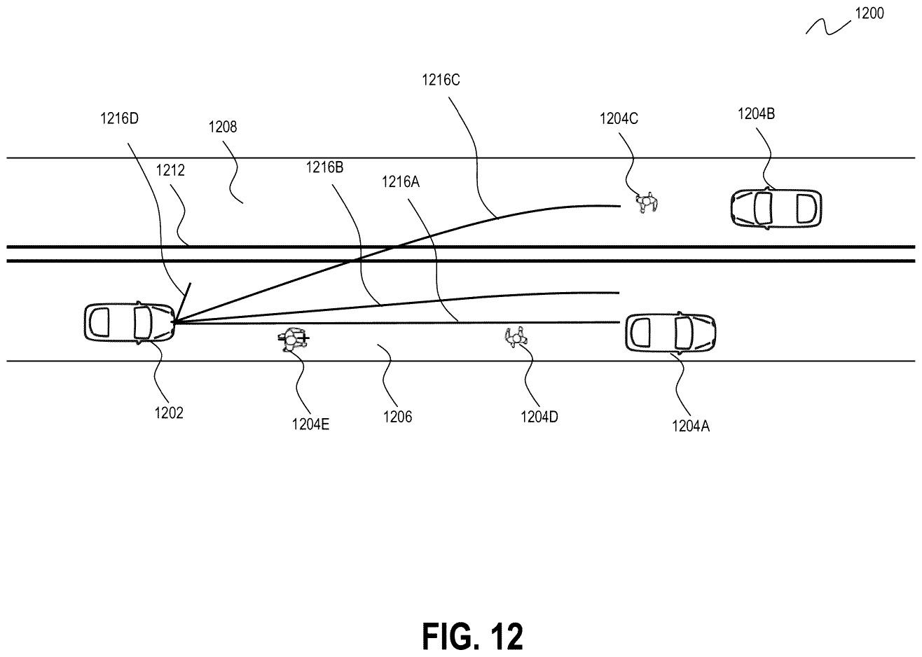

FIG. 12 is an example environment 1200 illustrating an example of a vehicle 1202 (e.g., a vehicle that is the same as, or similar to, vehicles 102 and/or vehicle 200) that is associated with an initial pose. The example environment 1200 may be based on one or more environmental parameters (e.g., including and/or indicating a lane 1206, a lane 1208, and/or a double line 1212) and one or more objects (e.g., including and/or indicating a vehicle 1204A, a vehicle 1204B, a pedestrian 1204C, a pedestrian 1204D, and/or a pedestrian 1204E). Each of the objects may have one or more object parameters (e.g., dynamic object parameters).

The vehicle 1202 can have an initial pose to identify an initial location, a starting location, etc. of the vehicle 1202. Based on the initial pose of the vehicle 1202, a system (e.g., the planning system 1102 of FIG. 11) can identify one or more trajectories for moving to a second pose (e.g., identifying a second or subsequent location) from the initial pose. All or a portion of the one or more trajectories can identify a different trajectory from the initial pose to a different second pose. In some cases, the one or more trajectories may be defined by a user, via a user computing device. In some cases, the one or more trajectories may be defined by the system based on sensor data, test data, etc.

All or a portion of the combinations of a particular trajectory with a particular environment can result in a significantly different experience for the vehicle and a user of the vehicle (e.g., a different rule violation, a different speed, etc.). For example, a first trajectory can cause the vehicle to speed up, a second trajectory can cause the vehicle to slow down, a third trajectory can cause the vehicle to turn into oncoming traffic, and a fourth trajectory can cause the vehicle to turn into an off ramp. In another example, a first trajectory in a first scenario (e.g., in a first environment with a first set of features, elements, characteristics, actors, etc. acting in a first manner) can cause the vehicle to violate a rule with a first priority (e.g., do not maneuver into a different lane) and the first trajectory in a second scenario (e.g., in a second environment with a second set of features, elements, characteristics, actors, etc. acting in a second manner) can cause the vehicle to violate a rule with a second priority (e.g., do not exceed the speed limit) that is lower compared to the first priority.

As described herein, the planning system 1102 (using the first trajectory generator 1110A) can determine the first subset of trajectories and (using the second trajectory generator 1110B) can determine the second subset of trajectories. The planning system 1102 can select a particular trajectory from the first subset of trajectories and the second subset of trajectories based on a likelihood of a rule violation and/or a distance from a rule violation. By selecting a trajectory based on a likelihood of a rule violation and/or a distance from a rule violation, the planning system 1102 can increase the likelihood that the selected trajectory causes a vehicle to violate a lower priority rule when a higher priority rule could be violated instead. Further, by selecting a trajectory from a first subset of trajectories and a second subset of trajectories that may include braking, non-braking, and/or partial braking safety-oriented trajectories, the planning system 1102 increases the safety of the vehicle.

In the illustrated example of FIG. 12, the environment 1200 includes the vehicle 1202. The environment 1200 may be similar to the environment 100 as described above with reference to FIG. 1 and/or environment 600 as described above with reference to FIG. 6. The environment 1200 further includes a first object: vehicle 1204A, a second object: vehicle 1204B, a third object: pedestrian 1204C, a fourth object: pedestrian 1204D, and a fifth object: pedestrian 1204E. It will be understood that the example environment 1200 may include more, less, or different features, elements, characteristics, actors, etc. For example, the example environment 1200 may include additional vehicles, bicycles, pedestrians, etc.

The example environment 1200 can include one or more environmental parameters (e.g., geographical features). In the example of FIG. 12, the example environment 1200 includes a road that is divided into multiple lanes (lane 1206 and lane 1208). The lanes are divided by a double line 1212. The example environment 1200 may include more, less, or different geographical features and/or artificial features. For example, the example environment 1200 may include a plurality of light sources, a plurality of trees, a median, an off ramp, etc.

The one or more environmental parameters and the objects may be static parameters or dynamic parameters. For example, in some cases, the objects may not vary over a time period. In some cases, the objects may vary over a time period. For example, the pedestrian 1204E may be in the environment during a first time period and not in the environment during a second time period.

The objects may be based on one or more object parameters and corresponding object parameter values. The object parameters can include actions of the objects, the types of the objects, and/or the location of the objects. The object parameters may be static parameters or dynamic parameters that can vary over a time period. For example, in some cases, the object parameters may not vary over a time period. In some cases, the object parameters may vary over a time period. For example, the pedestrian 1204E may be walking in a first direction during a first time period and running in a second direction during a second time period.

In the example of FIG. 12, the vehicle 1202 is operating in lane 1206. The vehicle 1202 is positioned at an initial pose in the lane 1206. Similarly, vehicle 1204A is positioned in the lane 1206. The vehicle 1204A is stopped at a location within the lane 1206. For example, the vehicle 1204A may be stopped at a location within the lane 1206 due to a mechanical issue, the vehicle 1204A can be picking up or dropping off a passenger, etc. The flow of traffic in lane 1206 is opposite to the flow of traffic in lane 1208.

Vehicle 1204B is positioned in the lane 1208. The vehicle 1204B may be stopped at a location within the lane 1208 or may be moving in a direction opposite the direction of vehicle 1202 (e.g., with the flow of traffic in lane 1208). For example, the vehicle 1204B may be stopped at a location within the lane 1208 due to a mechanical issue, the vehicle 1204B can be picking up or dropping off a passenger, etc.

The pedestrian 1204C, the pedestrian 1204D, and the pedestrian 1204E are positioned in the lane 1206 or the lane 1208. The pedestrian 1204C, the pedestrian 1204D, and the pedestrian 1204E may be stopped at a location within the lane 1206 and/or the lane 1208 or may be crossing the lane 1206 and/or the lane 1208. For example, all or a portion of the pedestrian 1204C, the pedestrian 1204D, and the pedestrian 1204E may be moving from one side of the road to the other side of the road.

The example environment 1200 may be associated with a hierarchical plurality of rules. For example, the hierarchical plurality of rules can include rules for vehicles navigating within the example environment 1200. In the example of FIG. 12, the traffic rules in the environment 1200 prohibit a vehicle from crossing the double line 1212, exceeding a predetermined speed limit (e.g., 45 miles per hour), approaching a stopped vehicle within a particular distance (e.g., within 5 meters), etc. in accordance with generally understood rules of the road.

In some cases, the vehicle 1202 may be navigating to a destination not shown in FIG. 12. For example, the vehicle 1202 may be navigating to a particular destination on a different road.

The example environment 1200 may include more, less, or different objects. For example, the example environment 1200 may include more, less, or different objects that can block a trajectory of the vehicle 1202. Pedestrians, construction, cyclists, etc. can block a trajectory of the vehicle 1202. The vehicle 1202 can utilize a planning system (e.g., planning system 1102 as described in FIG. 11) to identify the objects and determine how to navigate the example environment 1200.

The planning system 1102 can identify a set of trajectories for the vehicle 1202 for a particular planning step. The planning system 1102 may generate the set of trajectories as part of generating a plurality of trajectories that includes multiple sets of trajectories corresponding to multiple planning steps. The set of trajectories for the vehicle 1202 can include driving into lane 1208 due to vehicle 1204A that is stopped in lane 1206, colliding with vehicle 1204A, maneuvering away from the vehicle 1204A but staying within the lane 1206, driving on a side of the road beside lane 1206, stopping, etc. A trajectory may be associated with a plurality of similar trajectories. For example, the set of trajectories can include multiple potential trajectories that involve driving into lane 1208. The multiple potential trajectories can include a different degree to which the vehicle 1202 enters the lane 1208, a different speed when driving in the lane 1208, a different time period for driving in the lane 1208, etc. Therefore, the set of trajectories can include multiple trajectories that are similar (e.g., multiple trajectories can exceed a threshold value (e.g., 75%) of similarity when compared).

The planning system 1102 can utilize a first trajectory generator to generate a first subset of trajectories of the set of trajectories. The first trajectory generator may generate the first subset of trajectories based on first criterion. For example, the first trajectory generator may generate the first subset of trajectories based on a first set of functions, objectives, goals, processes, models, sensor data, etc.

The planning system 1102 can utilize a second trajectory generator of a second subset of trajectories of the set of trajectories. The second trajectory generator may generate the second subset of trajectories based on second criterion (different from the first criterion). For example, the second trajectory generator may generate the second subset of trajectories based on a second set of functions, objectives, goals, processes, models, sensor data, etc.

The planning system 1102 can select a trajectory from the set of trajectories for the vehicle. For example, the planning system 1102 can select a trajectory from the first subset of trajectories and the second subset of trajectories. In some cases, the planning system 1102 can select a first trajectory from the first subset of trajectories based on the hierarchical plurality of rules, and can select a second trajectory from the second subset of trajectories based on the hierarchical plurality of rules. The planning system 1102 can select the trajectory from the first trajectory and the second trajectory.

In the example of FIG. 12, the planning system 1102 identifies the first trajectory 1216A, the second trajectory 1216B, the third trajectory 1216C, and the fourth trajectory 1216D. For example, the first subset of trajectories may include the first trajectory 1216A, the second trajectory 1216B, and the third trajectory 1216C and the second subset of trajectories may include the fourth trajectory 1216D.

Using the hierarchical plurality of rules, the planning system 1102 identifies that the first subset of trajectories cause violation of particular rules based on sensor data from one or more sensors of the vehicle 1202 and indicative of the environment 1200. For example, the planning system 1102 identifies that the first trajectory 1216A causes a violation of a first rule that prohibits collisions with another vehicle, the second trajectory 1216B causes a violation of a second rule that prohibits a vehicle from approaching a particular distance of another vehicle, and the third trajectory 1216C causes a violation of a third rule that prohibits a vehicle from entering a lane of traffic that is flowing in a direction that is oriented differently from a direction of the trajectory.

In some cases, based on determining a rule that each of the first subset of trajectories causes the vehicle 1202 to violate, the planning system 1102 can identify and select a trajectory from the first subset of trajectories that causes a violation of a rule that satisfies (e.g., is below) a threshold priority (e.g., such as a trajectory that causes a violation of a lowest priority rule as compared to the priority of other rules that other trajectories of the first subset of trajectories cause to be violated). For example, the rule that the trajectories cause the vehicle 1202 to violate may be a rule prohibiting approaching a particular distance of another vehicle (e.g., based on the second trajectory 1216B) and the planning system 1102 may select the second trajectory 1216B. In some cases, the planning system 1102 can select a trajectory and one or more alternative trajectories from the first subset of trajectories. The planning system 1102 may filter out the unselected trajectories (e.g., trajectories not selected as the trajectory and not selected as the alternative trajectory) from the first subset of trajectories. In the example of FIG. 12, the planning system 1102 may select the second trajectory 1216B as the trajectory and the first trajectory 1216A and the third trajectory 1216C as alternative trajectories.

Subsequent to generation of the first subset of trajectories and/or selection of a trajectory (or trajectories) from the first subset of trajectories and filtering out of the unselected trajectories, the planning system 1102 may obtain updated sensor data associated with a sensors of the vehicle 1202 and indicative of the environment 1200 and determine rule violation data based on the updated sensor data. The rule violation data may indicate a likelihood of a rule violation by the vehicle 1202, a distance from a rule violation by the vehicle 1202 (e.g., a physical distance, a temporal distance, etc.), etc. In some cases, the rule violation data may indicate a likelihood of and/or a distance from a particular rule violation based on implementation of a selected trajectory from the first subset of trajectories (e.g., the selected trajectory is predicted to cause and/or result in a collision). In some cases, the rule violation data may indicate a likelihood of and/or a distance from a particular rule violation based on a state of the vehicle (e.g., a speed, an acceleration, a location, etc. of the vehicle is predicted to result in a collision).

The planning system 1102 may determine the rule violation data based on sensor data associated with a sensor of the vehicle 1202. For example, the planning system 1102 may identify a location of a pedestrian, a speed of the pedestrian, a speed of the vehicle 1202, etc. based on the sensor data and may determine rule violation data based on the identified location of the pedestrian, identified speed of the pedestrian, identified speed of the vehicle 1202, etc. In some cases, the same sensor data may be utilized to determine the rule violation data and to determine the second subset of trajectories.

The planning system 1102 may generate the first subset of trajectories and/or identify that the first subset of trajectories cause violation of particular rules based on first sensor data associated with a sensor of the vehicle 1202 and indicative of the environment 1200 and may identify the rule violation data based on second sensor data associated with a sensor of the vehicle 1202 and indicative of the environment 1200. The first sensor data may be associated with (e.g., obtained over) a first time period and the second sensor data may be associated with (e.g., obtained over) a second time period subsequent to the first time period. For example, the first sensor data may indicate that the pedestrian 1204D is located on a sidewalk and the planning system 1102 may predict that the pedestrian 1204D will remain on the sidewalk, however, the second sensor data, obtained subsequent to the first sensor data, may indicate that the pedestrian 1204D is located in the lane 1206 and the planning system 1102 may predict that the pedestrian 1204D will cross continue moving across the lane 1206 which may cause a selected trajectory to cause violation of a different rule (e.g., a rule with a higher priority as compared to a previous rule of which the trajectory was predicted to cause violation). In some cases, the second sensor data may be updated sensor data relative to the first sensor data. Therefore, the planning system 1102 (e.g., the second trajectory generator 1110B) can utilize the updated sensor data to identify (e.g., update) the rules that the first subset of trajectories may cause (e.g., are predicted to cause) the vehicle to violate.

The planning system 1102 may analyze the rule violation data utilizing threshold data. For example, the planning system 1102 may compare the rule violation data to one or more thresholds. Based on analyzing the rule violation data, the planning system 1102 may select a trajectory from the set of trajectories. For example, the planning system 1102 may select a trajectory from the first subset of trajectories (e.g., a previously selected trajectory) based on determining the rule violation data (e.g., the priority of a rule violation) is less than the one or more thresholds and may select a trajectory from the second subset of trajectories based on determining the rule violation data is greater than or matches the one or more thresholds.

In some cases, the planning system 1102 may determine a particular rule of the hierarchical plurality of rules (e.g., a highest priority rule as compared to other rules of the hierarchical plurality of rules). For example, a computing device may provide input indicating the particular rule. The planning system 1102 may obtain rule violation data associated with the particular rule. For example, the planning system 1102 may identify a rule prohibiting approaching a particular distance of another vehicle and may obtain rule violation data associated with the particular rule.

In some cases, the planning system 1102 may obtain rule violation data associated with all or a portion of the hierarchical plurality of rules. For example, the planning system 1102 may obtain rule violation data associated with a first rule, rule violation data associated with a second rule, etc.

In the example of FIG. 12, the planning system 1102 may analyze the rule violation data and determine that the likelihood of a particular rule violation is greater than or matches one or more thresholds and/or the distance from a particular rule violation is less than or matches one or more thresholds. For example, the planning system 1102 may analyze the rule violation data and determine that the likelihood of approaching a particular distance from pedestrian 1204E exceeds or matches the one or more thresholds.

In some cases, based on determining that the likelihood of the particular rule violation exceeds or matches one or more thresholds and/or the distance from the particular rule violation is less than or matches one or more thresholds, the planning system 1102 may select a trajectory from the second subset of trajectories (e.g., the fourth trajectory 1216D). For example, the planning system 1102 may select the fourth trajectory 1216D (e.g., the safety-oriented trajectory) to avoid the particular rule violation.

In some cases, based on determining that the likelihood of a particular rule violation exceeds or matches one or more thresholds and/or the distance from the particular rule violation is less than or matches one or more thresholds, the planning system 1102 may select the second subset of trajectories. For example, the planning system 1102 may compare the second subset of trajectories, select a trajectory based on the comparison, filter the unselected trajectories from the second subset of trajectories (such that the second subset of trajectories includes a single trajectory), select the second subset of trajectories (the filtered second subset of trajectories) based on determining that the likelihood of a particular rule violation exceeds or matches one or more thresholds and/or the distance from the particular rule violation is less than or matches one or more thresholds, and identify the previously selected trajectory from the selected second subset of trajectories.

As discussed above, because of the corresponding latency in generation of the first subset of trajectories, the first subset of trajectories may be outdated and/or may not be an accurate representation of the environment 1200 at a particular time after the sensor data is obtained on which the first subset of trajectories is based. As the second subset of trajectories may be generated utilizing different criterion as compared to the criterion utilized to generate the first subset of trajectories and may have a shorter corresponding latency, the second subset of trajectories may be an updated representation of the environment 1200. For example, the first subset of trajectories may be based on the pedestrian 1204E having a first location in lane 1206 and a first predicted movement (e.g., moving in the direction of the flow of traffic in lane 1206) and the second subset of trajectories may be based on the pedestrian 1204E having a second location in lane 1206 and a second predicted movement (e.g., rapid braking, swerving, etc.).

In some cases, the planning system 1102 may determine that the likelihood of a particular rule violation is less than one or more thresholds and/or the distance from a particular rule violation is greater than one or more thresholds.

In some cases, based on determining that the likelihood of a particular rule violation is less than one or more thresholds and/or the distance from a particular rule violation is greater than one or more thresholds, the planning system 1102 may select a trajectory from the first subset of trajectories. For example, the planning system 1102 may select the second trajectory 1216B based on the hierarchical plurality of rules.

In some cases, based on determining that the likelihood of a particular rule violation is less than one or more thresholds and/or the distance from the particular rule violation is greater than one or more thresholds, the planning system 1102 may select the first subset of trajectories. For example, the planning system 1102 may compare the first subset of trajectories, select a trajectory based on the comparison, filter the unselected trajectories from the first subset of trajectories (such that the first subset of trajectories includes a single trajectory), select the first subset of trajectories (the filtered first subset of trajectories) based on determining that the likelihood of a particular rule violation is less than one or more thresholds and/or the distance from the particular rule violation is greater than one or more thresholds, and identify the previously selected trajectory from the selected first subset of trajectories.

Based on the selected trajectory, the planning system 1102 may build a path for the vehicle 1202. The planning system 1102 may cause navigation of the vehicle 1202 based on the path. For example, the planning system 1102 may provide the selected trajectory to a control system of the vehicle 1202. In some cases, the planning system 1102 may provide the selected trajectory (e.g., the fourth trajectory 1216D or the second trajectory 1216B) and a backup shorter term trajectory (e.g., the fourth trajectory 1216D) to the control system of the vehicle 1202.

### Example Operating Diagrams of a Planning System

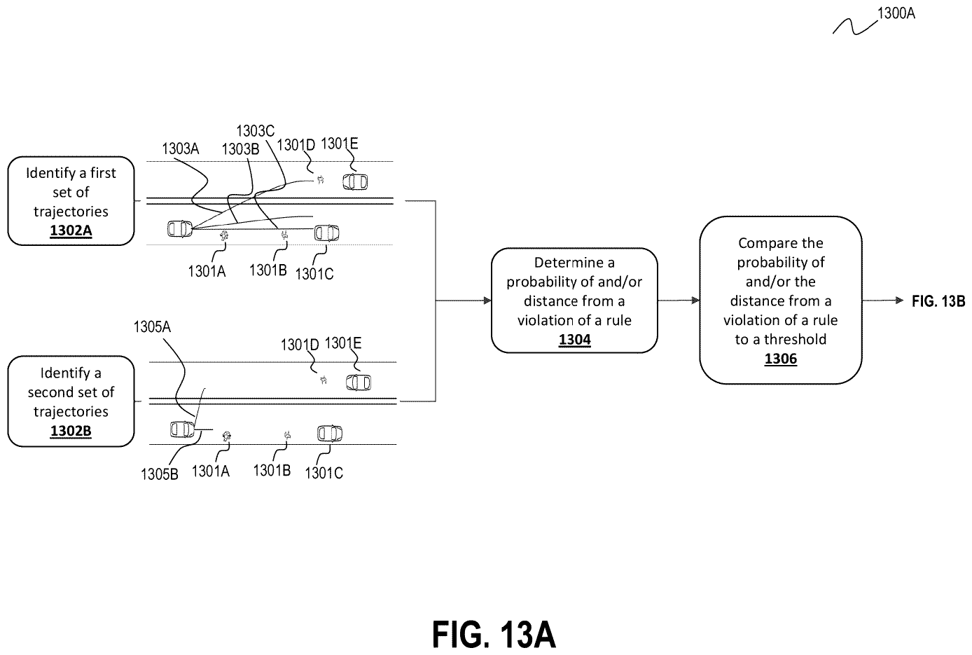

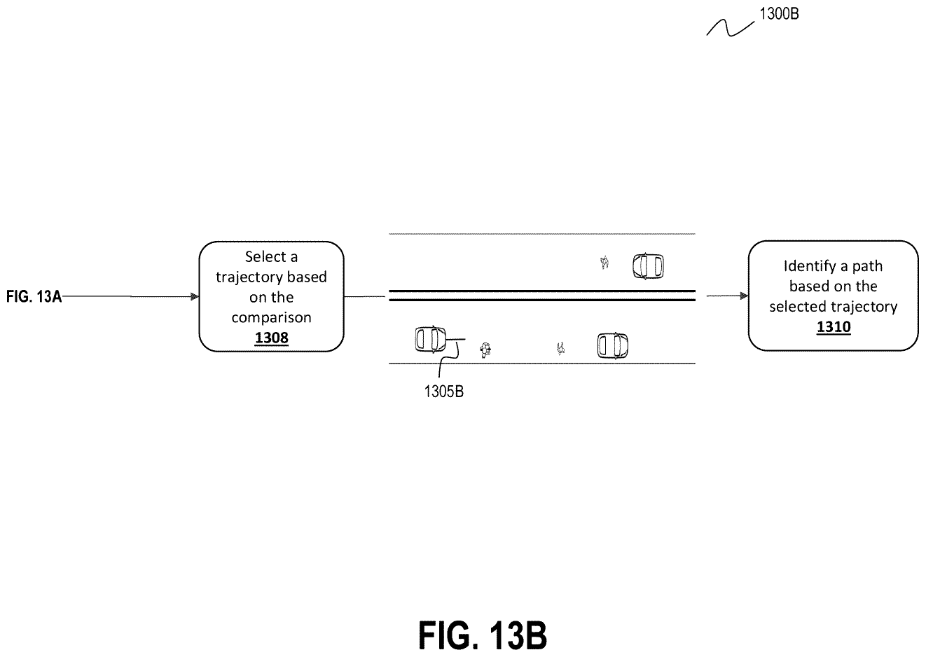

FIGS. 13A and 13B are operation diagrams illustrating a data flow for identifying a path for a vehicle. Specifically, FIGS. 13A and 13B are operation diagrams illustrating a data flow for identifying a first subset of trajectories and a second subset of trajectories for a vehicle during a planning step and selecting a trajectory for the vehicle based on rule violation data. Any component of the planning system 404 can facilitate the data flow for identifying a path for the vehicle based on the selected trajectory. In some embodiments, a different component can facilitate the data flow. In the example of FIG. 13A and FIG. 13B, a planning system (e.g., planning system 1102) facilitates the data flow.

At step 1302A, the planning system 1102 identifies a first subset of trajectories that includes trajectory 1303A, trajectory 1303B, and trajectory 1303C. The planning system 1102 identifies the first subset of trajectories from a plurality of trajectories. To identify the first subset of trajectories, the planning system 1102 can identify a plurality of trajectories that includes a respective first subset of trajectories for all or a portion of the planning steps of the path generation process. In some cases, the planning system 1102 can identify the first subset of trajectories, from the plurality of trajectories, prior to, during, or after a planning step of a path generation process. For example, the planning system can identify a respective first subset of trajectories at all or a portion of the planning steps.

The planning system 1102 may generate the first subset of trajectories C prior to a plurality of planning steps of the path generation process and may continuously refine and/or update the first subset of trajectories. Further, the planning system 1102 can refine the first subset of trajectories based on trajectories selected in prior planning steps of the path generation process. In some cases, the planning system 1102 can automatically and/or continuously refine the first subset of trajectories.

The planning system 1102 may generate the first subset of trajectories based on sensor data indicative of environmental parameter(s) and/or object(s) in the environment. In the illustrated example, the environmental parameters indicate a two lane road with a marking between the two lanes and the objects include pedestrians 1301A, 1301B, and 1301D and vehicles 1301C and 1301E.

The planning system 1102 identifies the first subset of trajectories as a movement from an initial pose of the vehicle based on the sensor data. In some cases, the first subset of trajectories may be defined as a series of intermediate poses between a first pose and a second pose.

In some cases, the planning system 1102 (or a separate system) can obtain input defining the first subset of trajectories (e.g., a first pose and a second pose associated with a given movement of the vehicle). The planning system 1102 can cause a computing device to display a user interface that receives input defining the first subset of trajectories. For example, the user interface can display a selection of trajectories for selection. In some cases, the user interface can receive written, audible, and/or image-based input defining the first subset of trajectories.

The planning system 1102 may generate the first subset of trajectories utilizing a first trajectory generator and based on first criterion (e.g., various functions, objectives, goals, processes, models, sensor data, etc.). For example, the planning system 1102 may generate the first subset of trajectories based on a planning objective, a cost function, a destination goal, etc.

The planning system 1102 may select a trajectory (or multiple trajectories) from the first subset of trajectories based on particular rules of the hierarchical plurality of rules that all or a portion of the first subset of trajectories are predicted to cause the vehicle to violate. For example, the planning system 1102 may select the trajectory 1303A as a primary trajectory, a main trajectory, etc. and may select the trajectory 1303B and the trajectory 1303C as alternative trajectories, backup trajectories, etc. In some cases, the planning system 1102 may filter out unselected trajectories from the first subset of trajectories.

At step 1302B, the planning system 1102 identifies a second subset of trajectories that includes trajectory 1305A and trajectory 1305B. Steps 1302A and 1302B may occur concurrently and/or simultaneously. For example, the planning system 1102 may generate a first subset of trajectories and a second subset of trajectories simultaneously. In some cases, steps 1302A and 1302B may occur during different time periods and/or using data received at different times. For example, the planning system 1102 may identify the first subset of trajectories with a first frequency and the planning system 1102 may identify the second subset of trajectories with a second frequency that is greater than the first frequency. In some cases, the planning system 1102 may identify the second subset of trajectories in response to identifying the first subset of trajectories and/or using more recent and/or updated sensor data.

The planning system 1102 may generate the second subset of trajectories based on (e.g., in response to) generation of the first subset of trajectories by the planning system 1102 and/or based on the planning system 1102 obtaining updated sensor data from a sensor of the vehicle. Additionally, the planning system 1102 may obtain updated sensor data and, in response, may generate the second subset of trajectories (without generating the first subset of trajectories). Accordingly, the second trajectory generator may generate multiple second subsets of trajectories for all or a portion of the planning steps.

In some cases, the second subset of trajectories may include a single trajectory (e.g., trajectory 1305B). The first subset of trajectories may include longer term trajectories and the second subset of trajectories may include shorter term trajectories. The first subset of trajectories may include longer term trajectories based on or prioritizing various long term criterion (e.g., destination based criterion, comfort based criterion, safety based criterion, etc.) and the second subset of trajectories may include shorter term trajectories based on or prioritizing various short term criterion (e.g., safety based criterion) as compared to the various long term criterion. While the shorter term trajectories and the longer term trajectories may be of similar length and/or correspond to similar time periods, the shorter term trajectories and the longer term trajectories may be different based on the respective criterion used to generate the shorter term trajectories and the longer term trajectories. For example, based on the differences between the long term criterion and the short term criterion, the longer term trajectories may be based on a longer time horizon as compared to the shorter term trajectories (e.g., 5-9 seconds as compared to 1-4 seconds), a greater latency as compared to the shorter term trajectories (e.g., 200-750 milliseconds as compared to 50 milliseconds), etc.

The second subset of trajectories may include swerving or braking trajectories (to increase safety and avoid a violation of a rule). In the example of FIG. 13A, trajectory 1305A is a swerving trajectory and trajectory 1305B is a braking trajectory.

The planning system 1102 may generate the second subset of trajectories utilizing a second trajectory generator and based on second criterion (e.g., various functions, objectives, goals, processes, models, sensor data, etc.) that is different from the first criterion.

The first criterion and/or the second criterion may include functions (e.g., cost functions to determine (and improve) performance of a trajectory generator, functions to generate trajectories, etc.), goals (e.g., reaching the destination, ensuring safety of a passenger of the objective, avoiding a violation of a rule of the hierarchical plurality of rules, ensuring comfort of a passenger, reducing uncertainty (of the passenger, drivers of other vehicles, pedestrians, etc.) in when the vehicle will arrive at a destination, reducing uncertainty (of the passenger, drivers of other vehicles, pedestrians, etc.) in a route that the vehicle will traverse, etc.), objectives (e.g., planner or planning objectives indicating operation of a trajectory generator), models (e.g., machine learning models), processes (e.g., planning processes), sensor data, actions (e.g., actions for the vehicle to utilize in particular scenarios such as initializing a turn signal prior to and during turning or switching lanes, initializing a brake light during braking, initializing high beam lights and/or a horn based on another vehicle, providing feedback to a passenger based on operation of the vehicle, etc.), etc. For example, the planning system 1102 can utilize a first planner objective and/or a first cost function to generate the first subset of trajectories based on first sensor data associated with the one or more sensors of the vehicle (e.g., a lidar sensor, an image sensor, a radar sensor, etc.) and utilize a second planner objective and/or a second cost function to generate the second subset of trajectories based on second sensor data associated with the one or more sensors. In another example, the planning system 1102 can utilize a first machine learning model trained to provide an output based on multiple objectives (e.g., reaching a destination, passenger safety, passenger comfort, etc.) to generate the first subset of trajectories and a second machine learning model trained to provide an output based on a single objective or less objectives as compared to the multiple objectives (e.g., passenger safety) to generate the second subset of trajectories. In another example, the planning system 1102 can generate the first subset of trajectories based on sensor data associated with a first horizon (e.g., 8 seconds) and generate the second subset of trajectories based on sensor data associated with a second horizon that is less than the first horizon (e.g., 3 seconds).

In some cases, the second criterion include a subset of the first criterion. For example, the first criterion may include multiple planning objectives (including a safety objective, such as avoid a collision) and the second criterion may include (only) the safety objective. Moreover, as the sensor data used to detect a potential collision (or other safety objective) may be less than the sensor data used to generate a longer term trajectory, the second trajectory generator may use less data and less compute resources to generate the second subset of trajectories in less time.

As discussed above, the planning system 1102 may generate the first subset of trajectories and the second subset of trajectories based on sensor data associated with a sensor of the vehicle (e.g., different sensor data). For example, the sensor data used for generation of the second subset of trajectories may be updated as compared to the sensor data used for generation of the first subset of trajectories. In one example, the sensor data used for generation of the second subset of trajectories may be indicative of a change in the environment of the vehicle (e.g., a movement of an object, a modification of a parameter of an object, an introduction of an additional object to the environment, a removal of an object from the environment, etc.) relative to the sensor data used for generation of the first subset of trajectories.

The planning system 1102 may generate the second subset of trajectories based on sensor data indicative of environmental parameter(s) and/or object(s) in the environment. In the illustrated example, the environmental parameters indicate a two lane road with a marking between the two lanes and the objects include pedestrians 1301A, 1301B, and 1301D and vehicles 1301C and 1301E.

In some cases, the planning system 1102 (or a separate system) can obtain input defining the second subset of trajectories and/or trajectory parameters for generating the second subset of trajectories. For example, the user interface can display a selection of swerving trajectories, braking trajectories, accelerating trajectories, etc.

At step 1304, the planning system 1102 determines a probability of and/or distance from a violation of a rule based on sensor data associated with a sensor of the vehicle (e.g., updated sensor data as compared to the sensor data used to generate the first subset of trajectories and/or select a trajectory from the first subset of trajectories). For example, the planning system 1102 may determine rule violation data indicative of a probability of and/or distance from a violation of a rule of a hierarchical plurality of rules.

In some cases, the planning system 1102 may analyze the sensor data to determine a probability of and/or a distance from a violation of a rule based on a state (e.g., a current speed, acceleration, location, etc.) of the vehicle. In some cases, the planning system 1102 may analyze the sensor data to determine a probability of and/or a distance from a violation of a rule based on the vehicle operating according to a trajectory (e.g., a previously selected trajectory) of the first subset of trajectories. The planning system 1102 may utilize first sensor data associated with a first time period to select a trajectory from the first subset of trajectories based on first sensor data and second sensor data associated with a second time period subsequent to the first time period to determine a probability of and/or distance from a violation of a rule. As the second sensor data may indicate changes within the environment of the vehicle relative to the first sensor data, the planning system 1102 may determine that a selected trajectory (e.g., a trajectory selected from the first subset of trajectories) is predicted to cause violation of a higher priority rule by the vehicle (e.g., a collision) as compared to the rule that the planning system 1102 predicted that the selected trajectory would cause violation of during selection of the particular trajectory.

As discussed above, to determine the probability of and/or distance from a violation of a rule, the planning system 1102 may obtain sensor data and may determine the probability of and/or the distance from a violation of a rule. In some cases, the planning system 1102 may obtain the sensor data utilized to generate the second subset of trajectories. In some cases, the planning system 1102 may obtain sensor data that is different from the sensor data utilized to generate the second subset of trajectories. For example, the sensor data may be updated as compared to the sensor data utilized to generate the second subset of trajectories.

In some cases, the planning system 1102 may determine rule violation data associated with a particular rule (e.g., a rule identifying a minimum distance between the vehicle and another vehicle).

At step 1306, the planning system 1102 compares the probability of and/or the distance from a violation of a rule to a threshold. The planning system 1102 can identify threshold data indicative of one or more thresholds (e.g., threshold values, threshold ranges, etc.). The planning system can identify a threshold of the one or more thresholds associated with and/or identified by the particular rule (e.g., a minimum threshold distance for the vehicle to maintain from another vehicle).

The planning system 1102 may compare the probability of and/or the distance from a violation of a rule to a threshold to determine whether the probability and/or distance is within, is greater than, is less than, matches, etc. the threshold.

FIG. 13B is an operation diagram 1300B for selecting a trajectory from a first subset and a second subset of trajectories and identifying a path for the vehicle. The operation diagram 1300A may correspond to a first portion of a planning step and the operation diagram 1300B may correspond to a second, subsequent portion of the planning step. In some examples, the first step and the second step are separated by one or more intermediate steps.

At step 1308, the planning system 1102 selects a trajectory 1305B (from trajectories generated using different criterion) based on the comparison of the probability of and/or the distance from a violation of a rule to a threshold. The planning system 1102 may select the trajectory 1305B from the first subset of trajectories (e.g., a previously selected trajectory) and the second subset of trajectories (e.g., a safety trajectory).

As the planning system 1102 may select a trajectory based on updated sensor data as compared to the sensor data used to generate the first subset of trajectories, the planning system can validate and/or verify a prior selection of trajectory from the first subset of trajectories. Therefore, the planning system 1102 may select a previously selected trajectory generated based on a first set of criterion by validating that updated sensor data does not indicate that the previously selected trajectory is predicted to result in a probability of and/or a distance from a violation of a rule or may select a trajectory from a second subset of trajectories (e.g., a safety trajectory) generated based on a second set of criterion based on determining that updated sensor data does indicate that the previously selected trajectory is predicted to result in a probability of and/or a distance from a violation of a particular rule (e.g., collision).

The planning system 1102 may select the trajectory 1305B based on determining that the probability of a violation of a rule matches, is greater than, or is within the threshold and/or that the distance from a violation of a rule matches, is less than, or is within the threshold. The planning system 1102 may select the trajectory 1305B (a braking trajectory) to avoid the violation of the rule and/or to decrease the consequences of the violation of the rule if the vehicle implements a trajectory of the first subset of trajectories (e.g., a trajectory previously selected from the first subset of trajectories).

At step 1310, the planning system 1102 identifies a path based on the selected trajectory. The planning system 1102 can dynamically build a path that includes the selected trajectory.

The planning system 1102 can generate path data that identifies the path. Further, the planning system 1102 can route the path data to a data destination, such as the control system 408 for operation of the vehicle.

As described herein, in some cases, the control system 408 may include one or more collision avoidance or AEB systems. The collision avoidance system may use sensor data to determine whether a collision is imminent (e.g., about to occur in less than seconds, or less than one second). If it is determined that a collision is imminent, the collision avoidance system can activate emergency braking or other collision avoidance mechanisms (e.g., emergency braking or maximum braking) to avoid the collision. In certain cases, the control system 408 may activate the collision avoidance mechanisms regardless of whether the planning system 1102 selected a trajectory from the first subset of trajectories or trajectory from the second subset of trajectories.

As described herein, the path generation process can be repeated thousands, hundreds of thousands, millions, or more times in order to generate paths for a vehicle (a path may include one or more trajectories). The planning system 1102 can combine one or more paths to form a route for a vehicle. By selecting a trajectory from the first and second subsets of trajectories, the planning system 1102 can identify a safer trajectory as compared to other trajectories of the first and second subsets of trajectories for a vehicle and improve a user experience.

In addition, during the path generation process, some of the functions or elements described herein may not be used or may not be present. For example, during the path generation process, the planning system 1102 may not generate a second subset of trajectories and may utilize a second subset of trajectories generated for a previous planning step.

### Example Flow Diagram of a Planning System

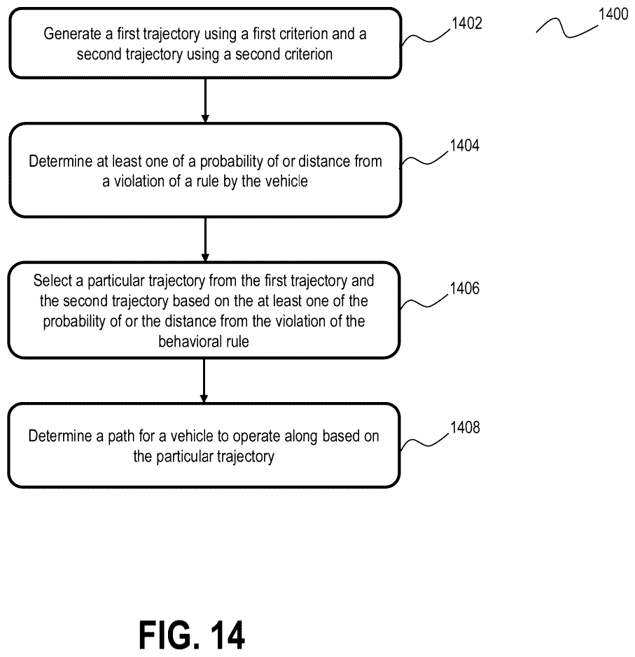

FIG. 14 is a flow diagram illustrating an example of a routine 1400 implemented by one or more processors (e.g., one or more processors of the planning system 1102). The flow diagram illustrated in FIG. 14 is provided for illustrative purposes only. It will be understood that one or more of the steps of the routine illustrated in FIG. 14 may be removed or that the ordering of the steps may be changed. Furthermore, for the purposes of illustrating a clear example, one or more particular system components are described in the context of performing various operations during each of the data flow stages. However, other system arrangements and distributions of the processing steps across system components may be used.

At block 1402, the planning system 1102 generates a first trajectory using a first criterion and a second trajectory using a second criterion (e.g., for a vehicle). The first trajectory and the second trajectory may correspond to a particular planning step of a plurality of planning steps of the path generation process and may represent different paths for the vehicle through the environment from a particular pose. The pose may be a first pose (e.g., an initial pose) of a path for a vehicle. In some cases, the first pose is a pose located at an end of a third trajectory which may be maintained and selected during a prior planning step. The first trajectory and the second trajectory can represent operation of the vehicle from the first pose. For example, the first trajectory may be from a first pose to a second pose and the second trajectory may be from the first pose to a third pose.

The first trajectory may be a longer term trajectory and the second trajectory may be a shorter term trajectory. The first trajectory may be a longer term trajectory based on or prioritizing various long term criterion (e.g., destination based criterion, comfort based criterion, safety based criterion, etc.) and the second trajectory may be a shorter term trajectories based on or prioritizing various short term criterion (e.g., safety based criterion) as compared to the various long term criterion. While the shorter term trajectory and the longer term trajectory may be of similar or the same length and/or correspond to similar or the same time periods, the shorter term trajectory and the longer term trajectory may be different based on the respective criterion used to generate the shorter term trajectory and the longer term trajectory. For example, based on the differences between the long term criterion and the short term criterion, the longer term trajectory may be based on or include a longer time horizon as compared to the shorter term trajectory (e.g., 6-9 seconds as compared to 1-4 seconds), a greater latency as compared to the shorter term trajectory (e.g., 300-850 milliseconds as compared to 20-100 milliseconds), etc.

The second trajectory may cause a vehicle to brake, swerve, accelerate, etc. (e.g., a braking trajectory, a turning trajectory, etc.).

In some cases, the planning system 1102 may generate the second trajectory concurrently with or based on generating the first trajectory. In some cases, the planning system 1102 may generate the second trajectory based on obtaining the second set of sensor data. Further, the planning system 1102 may generate the first trajectory at a first frequency and may generate the second trajectory at a second frequency that is greater than the first frequency. For example, the planning system 1102 may generate the second trajectory at a greater frequency and a lower latency as compared to the generation of the first trajectory by the planning system 1102.

As discussed above, the planning system 1102 may generate the first trajectory using the first criterion (e.g., one or more first functions, objectives, goals, processes, models, sensor data, etc.) and the second trajectory using the second criterion (e.g., one or more second functions, objectives, goals, processes, models, sensor data, etc.). The first criterion and/or the second criterion may include functions (e.g., cost functions to determine (and improve) performance of a trajectory generator, functions to generate trajectories, etc.), goals (e.g., reaching the destination, ensuring safety of a passenger of the objective, avoiding a violation of a rule of the hierarchical plurality of rules, ensuring comfort of a passenger, etc.), objectives (e.g., planner or planning objectives indicating operation of a trajectory generator), models (e.g., machine learning models), processes (e.g., planning processes), sensor data, etc. For example, the planning system 1102 can utilize a first planner objective and/or a first cost function to generate the first subset of trajectories based on first sensor data associated with the one or more sensors of the vehicle (e.g., a lidar sensor, an image sensor, a radar sensor, etc.) and utilize a second planner objective and/or a second cost function to generate the second subset of trajectories based on second sensor data associated with the one or more sensors.

In some cases, the planning system 1102 may generate the first trajectory and the second trajectory based on sensor data associated with different sensors. For example, the planning system 1102 may generate the first trajectory based on a first set of sensor data associated with a first sensor (e.g., of the vehicle) and may generate the second trajectory based on a second set of sensor data associated with a second sensor (e.g., of the vehicle).

In some cases, the first set of sensor data may correspond to a first time period (e.g., may be captured over a first time period) and the second set of sensor data may correspond to a second time period (e.g., may be captured over a second time period). For example, the second time period may be subsequent (e.g., temporally) to the first time period. In some cases, the planning system 1102 may obtain an update to the first set of sensor data that includes the second set of sensor data.

In some cases, the planning system 1102 may utilize multiple trajectory generators. For example, the planning system 1102 may utilize a first trajectory generator and a second trajectory generator (e.g., a reflexive trajectory generator). The planning system 1102 may utilize the first trajectory generator to generate the first subset of trajectories and the second trajectory generator to generate the second subset of trajectories.

The planning system 1102 can receive rule data identifying a hierarchical plurality of rules. All or a portion of the hierarchical plurality of rules may have a priority with respect to all or a portion of the other rules of the hierarchical plurality of rules. For example, a rule may identify that the vehicle is to maintain a distance from a parked vehicle, the vehicle is to reach a particular pose or destination, the vehicle is to stay in a lane, etc.

In some cases, the planning system 1102 may obtain a plurality of first trajectories (e.g., generated by a first trajectory generator) and/or a plurality of second trajectories (e.g., generated by a second trajectory generator). The planning system 1102 may assign a weight to all or a portion of the trajectories. For example, the planning system 1102 may assign a rule violation value to each trajectory based on the rule(s) that the respective trajectory causes to be violated. The weight may identify a risk associated with a particular trajectory and the given rule violation values. The planning system 1102 may select the first trajectory from the first plurality of trajectories and/or the second trajectory from the second plurality of trajectories based on the rule violation values and sensor data associated with a sensor of the vehicle.

At block 1404, the planning system 1102 determines at least one of a probability of or a distance from a violation of a rule (e.g., a behavioral rule) by the vehicle (e.g., based on updated sensor data). For example, the planning system 1102 may select the first trajectory from the first plurality of trajectories and/or the second trajectory from the second plurality of trajectories based on first sensor data associated with a sensor of the vehicle and may determine at least one of a probability of or a distance from a violation of a rule (e.g., a behavioral rule) by the vehicle based on second sensor data associated with a sensor of the vehicle that is obtained and/or generated subsequent to the first sensor data. In another example, the planning system 1102 may select the first trajectory from the first plurality of trajectories based on first sensor data associated with a sensor of the vehicle, may select the second trajectory from the second plurality of trajectories based on second sensor data associated with a sensor of the vehicle that is obtained and/or generated subsequent to the first sensor data, and may determine at least one of a probability of or a distance from a violation of a rule (e.g., a behavioral rule) by the vehicle based on the second sensor data

To determine the at least one of the probability of or the distance from the violation of the rule, the planning system 1102 may obtain rule violation data (e.g., based on sensor data) and may determine the at least one of the probability of or the distance from the violation of the rule based on the rule violation data. The planning system 1102 may determine (e.g., predict) the at least one of the probability of or the distance from the violation of the rule based on implementation of the first trajectory (e.g., a previously selected trajectory) and/or a current state of the vehicle (e.g., a speed, acceleration, location, etc. of the vehicle).

In one example, the planning system 1102 may determine the at least one of a probability of or a distance from a violation of a rule by determining a probability of at least one of a collision or a clearance violation by the vehicle. In another example, the planning system 1102 may determine the at least one of a probability of or a distance from a violation of a rule by determining a physical distance between a position of the vehicle and position of at the at least one of the collision or the clearance violation by the vehicle. In another example, the planning system 1102 may determine the at least one of a probability of or a distance from a violation of a rule by determining a distance with respect to time (e.g., a temporal distance) of the at least one of the collision or the clearance violation. For example, the distance with respect to time may be based on a difference between a time at which the probability is determined (e.g., a current time) and an estimated time of the at least one of the collision or the clearance violation.

At block 1406, the planning system 1102 selects a particular trajectory from the first trajectory (e.g., a trajectory previously selected by the planning system 1102) and the second trajectory (e.g., a safety trajectory) based on the at least one of the probability of or the distance from the violation of the behavioral rule. For example, the planning system 1102 may select a particular trajectory based on comparing the at least one of the probability of or the distance from the violation of the behavioral rule to one or more thresholds.

In some cases, the planning system 1102 may determine that at least one of the probability of the violation of the rule is greater than or matches a threshold (e.g., a first threshold value) or the distance from the violation of the rule is less than or matches a threshold (e.g., a second threshold value). Based on determining that at least one of the probability of the violation of the rule is greater than or matches a threshold or the distance from the violation of the rule is less than or matches a threshold, the planning system 1102 can select the second trajectory (e.g., a safety trajectory) from the first trajectory and the second trajectory as the particular trajectory.

In some cases, the planning system 1102 may determine that at least one of the probability of the violation of the rule is less than a threshold (e.g., a first threshold value) or the distance from the violation of the rule is greater than a threshold (e.g., a second threshold value). Based on determining that at least one of the probability of the violation of the rule is less than a threshold or the distance from the violation of the rule is greater than a threshold, the planning system 1102 can select the first trajectory (e.g., a previously selected trajectory) from the first trajectory and the second trajectory as the particular trajectory.

At block 1408, the planning system 1102 determines a path for the vehicle to operate along based on the selected trajectory. The path may include a sequence of trajectories from an initial pose to an end pose. The path may include the selected trajectory and one or more additional trajectories. For example, as discussed above, the path may include the second trajectory and a third trajectory. The planning system 1102 can determine a route for the vehicle using the path. For example, the route may include one or more paths.

The planning system 1102 can route the path (or a route that includes the path) to a data destination. For example, the planning system 1102 can route the path to control system 408 for navigation of a vehicle, etc. The planning system 1102 can transmit a message to the control system of the vehicle to operate (cause operation of the vehicle based on the path). In some cases, the planning system 1102 can transmit the selected trajectory and an alternative trajectory (e.g., the second trajectory) to the control system. For example, the planning system 1102 may transmit the first trajectory and the second trajectory to the control system or may transmit two copies of the second trajectory to the control system (e.g., where the selected trajectory and the alternative trajectory are both the second trajectory).

In some cases, the selection of the trajectory by the planning system 1102 may be overridden. For example, as described herein, the control system may include a collision avoidance or AEB system, which may override the selection based on a third set of sensor data from one or more sensors of the vehicle (e.g., indicating that a portion of the vehicle or a computing device of the vehicle is unavailable, unresponsive, not powered, etc.), or based on a determination of an imminent collision.

In some cases, the planning system 1102 causes display of the path via a display of a computing device. For example, the planning system 1102 can cause display of a geographical map that identifies a location of the path. Further, the planning system 1102 can cause display of an indicator of the rules violated by the path. In some cases, the planning system 1102 generates a graph that identifies the path. The planning system 1102 can cause display of the graph.

In some cases, the planning system 1102 may iteratively generate first and second subsets of trajectories for planning steps (e.g., for n iterations, where n can be any number). For example, for each iteration, the planning system 1102 may iteratively generate first and second subsets of trajectories. The planning system 1102 may select a subsequent trajectory from the iteratively generated first and second subsets of trajectories and add the subsequent trajectory to the path for the vehicle.

For example, the planning system 1102 may select the first trajectory (e.g., generated by the first trajectory generator) for a first planning step and a third trajectory (e.g., generated by the second trajectory generator) for a second planning step. The planning system 1102 may select the third trajectory for the second planning step based on determining at least one of a second probability of a violation of the rule is greater than or matches the threshold or a second distance from a violation of the rule is less than or matches the threshold. The planning system 1102 may determine a first path for the vehicle to operate along based on selecting the first trajectory and a second path for the vehicle to operate along based on selecting the third trajectory.

It will be understood that the routine 1400 can be repeated multiple times using different location data (e.g., different initial poses, etc.) and/or different objects in an environment of the vehicle. In some cases, the planning system 1102 iteratively repeats the routine 1400 for multiple vehicles within the same environment. Further, the planning system 1102 can repeat the routine 1400 for the same vehicle during different time periods.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously recited step or entity.

Various additional example embodiments of the disclosure can be described by the following clauses:

Clause 1: A method comprising:
generating, using at least one processor, a first trajectory for a vehicle based on a first set of criterion;
generating, using the at least one processor, a second trajectory for the vehicle based on a second set of criterion;
determining, using the at least one processor, at least one of a probability of a violation of a behavioral rule by the vehicle or a distance from the violation of the behavioral rule;
selecting, using the at least one processor, a particular trajectory from the first trajectory and the second trajectory based on the at least one of the probability of the violation of the behavioral rule or the distance from the violation of the behavioral rule; and
determining, using the at least one processor, a path for the vehicle to operate along based on the particular trajectory.

Clause 2: The method of Clause 1, further comprising:
determining at least one of the probability of the violation of the behavioral rule is greater than or matches a first threshold value or the distance from the violation of the behavioral rule is less than or matches a second threshold value,
   wherein selecting the particular trajectory from the first trajectory and the second trajectory comprises:
selecting the second trajectory from the first trajectory and the second trajectory based on determining the at least one of the probability of the violation of the behavioral rule is greater than or matches the first threshold value or the distance from the violation of the behavioral rule is less than or matches the second threshold value.

Clause 3: The method of Clause 1 or Clause 2, further comprising:
determining at least one of the probability of the violation of the behavioral rule is less than a first threshold value or the distance from the violation of the behavioral rule is greater than a second threshold value,
wherein selecting the particular trajectory from the first trajectory and the second trajectory comprises:
selecting the first trajectory from the first trajectory and the second trajectory based on determining at least one of the probability of the violation of the behavioral rule is less than the first threshold value or the distance from the violation of the behavioral rule is greater than the second threshold value.

Clause 4: The method of any one of Clauses 1 through 3, wherein generating the first trajectory comprises:
generating the first trajectory based on a first set of sensor data associated with a sensor of the vehicle, and
wherein generating the second trajectory comprises:
generating the second trajectory based on a second set of sensor data associated with the sensor,
the method further comprising:
obtaining the first set of sensor data corresponding to a first time period; and
obtaining the second set of sensor data corresponding to a second time period, wherein the second time period is subsequent to the first time period.

Clause 5: The method of any one of Clauses 1 through 4, wherein generating the first trajectory comprises:
generating the first trajectory based on a first set of sensor data associated with a sensor of the vehicle, and
wherein generating the second trajectory comprises:
generating the second trajectory based on a second set of sensor data associated with the sensor,
the method further comprising:
obtaining the first set of sensor data; and
obtaining an update to the first set of sensor data comprising the second set of sensor data.

Clause 6: The method of any one of Clauses 1 through 5, wherein generating the first trajectory comprises:
generating the first trajectory from a first pose to a second pose, and
wherein generating the second trajectory comprises:
generating the second trajectory from the first pose to a third pose.

Clause 7: The method of any one of Clauses 1 through 6, wherein determining the at least one of the probability of or the distance from the violation of the behavioral rule by the vehicle comprises at least one of:
determining a probability of at least one of a collision or a clearance violation by the vehicle;
determining a physical distance between a position of the vehicle and a position of at least one of a collision or a clearance violation by the vehicle; or
determining a distance with respect to time of at least one of a collision or a clearance violation by the vehicle.

Clause 8: The method of any one of Clauses 1 through 7, wherein generating the second trajectory comprises:
generating a turning trajectory; or
generating a braking trajectory.

Clause 9: The method of any one of Clauses 1 through 8, wherein generating the second trajectory comprises:
generating the second trajectory based on generating the first trajectory.

Clause 10: The method of any one of Clauses 1 through 9, wherein generating the second trajectory comprises:
obtaining a set of sensor data; and
generating the second trajectory based on obtaining the set of sensor data.

Clause 11: The method of any one of Clauses 1 through 10, wherein generating the first trajectory comprises:
generating the first trajectory using a first trajectory generator,
wherein generating the second trajectory comprises:
generating the second trajectory using a second trajectory generator.

Clause 12: The method of any one of Clauses 1 through 11, wherein generating the first trajectory comprises:
generating the first trajectory using a first trajectory generator at a first frequency,
wherein generating the second trajectory comprises:
generating the second trajectory using a second trajectory generator at a second frequency greater than the first frequency.

Clause 13: The method of any one of Clauses 1 through 12, further comprising:
transmitting a message to a control system of the vehicle to operate the vehicle based on the path for the vehicle.

Clause 14: The method of any one of Clauses 1 through 13, further comprising:
transmitting the first trajectory and the second trajectory to a control system of the vehicle; and
transmitting a message to a control system of the vehicle to operate the vehicle based on the path for the vehicle.

Clause 15: The method of any one of Clauses 1 through 14, further comprising:
transmitting the particular trajectory and an alternative trajectory to a control system of the vehicle, wherein the particular trajectory and the alternative trajectory each comprise the second trajectory; and
transmitting a message to a control system of the vehicle to operate the vehicle based on the path for the vehicle.

Clause 16: The method of any one of Clauses 1 through 15, wherein generating the first trajectory comprises:
generating the first trajectory based on at least one of a first planner objective or a first cost function,
wherein generating the second trajectory comprises:
generating the second trajectory based on least one of a second planner objective or a second cost function.

Clause 17: The method of any one of Clauses 1 through 16, wherein generating the first trajectory comprises:
generating the first trajectory using a first trajectory generator, and
wherein generating the second trajectory comprises:
generating the second trajectory using a second trajectory generator,
the method further comprising:
determining at least one of the probability of the violation of the behavioral rule is less than a first threshold value or the distance from the violation of the behavioral rule is greater than a second threshold value, wherein selecting the particular trajectory from the first trajectory and the second trajectory comprises selecting the first trajectory from the first trajectory and the second trajectory based on determining the at least one of the probability of the violation of the behavioral rule is less than the first threshold value or the distance from the violation of the behavioral rule is greater than the second threshold value;
determining at least one of a second probability of the violation of the behavioral rule is greater than or matches the first threshold value or a second distance from the violation of the behavioral rule is less than or matches the second threshold value;
selecting a third trajectory generated by the second trajectory generator based on determining the at least one of the second probability of the violation of the behavioral rule is greater than or matches the first threshold value or the second distance from the violation of the behavioral rule is less than or matches the second threshold value; and
determining a second path for the vehicle to operate along based on selecting the third trajectory.

Clause 18: The method of any one of Clauses 1 through 17, wherein selecting the particular trajectory from the first trajectory and the second trajectory comprises:
selecting the first trajectory from the first trajectory and the second trajectory based on determining the at least one of the probability of or the distance from the violation of the behavioral rule by the vehicle is less than a threshold value, wherein selection of the first trajectory is overridden based on a set of sensor data associated with a sensor.

Clause 19: The method of any one of Clauses 1 through 18, wherein the first set of criterion comprises at least one of a first set of sensor data associated with a sensor, a first cost function, or a first planning objective, wherein the second set of criterion comprises at least one of a second set of sensor data associated with the sensor or a safety objective, and wherein the first set of criterion and the second set of criterion comprise different criterion.

Clause 20: A system comprising:
at least one processor, and
at least one non-transitory storage media storing instructions that, when executed by the at least one processor, cause the at least one processor to:
generate a first trajectory for a vehicle based on a first set of criterion;
generate a second trajectory for the vehicle based on a second set of criterion;
determine at least one of a probability of or a distance from a violation of a behavioral rule by the vehicle;
select a particular trajectory from the first trajectory and the second trajectory based on the at least one of the probability of or the distance from the violation of the behavioral rule; and
determine a path for the vehicle to operate along based on the particular trajectory.

Clause 21: At least one non-transitory storage media storing instructions that, when executed by a computing system comprising a processor, cause the computing system to:
generate a first trajectory for a vehicle based on a first set of criterion;
generate a second trajectory for the vehicle based on a second set of criterion;
determine at least one of a probability of or a distance from a violation of a behavioral rule by the vehicle;
select a particular trajectory from the first trajectory and the second trajectory based on the at least one of the probability of or the distance from the violation of the behavioral rule; and
determine a path for the vehicle to operate along based on the particular trajectory.

Clause 22: The system of Clause 20, wherein execution of the instructions by the at least one processor further causes the at least one processor to:
determine at least one of the probability of the violation of the behavioral rule is greater than or matches a first threshold value or the distance from the violation of the behavioral rule is less than or matches a second threshold value,
wherein to select the particular trajectory from the first trajectory and the second trajectory, the execution of the instructions by the at least one processor further causes the at least one processor to:
select the second trajectory from the first trajectory and the second trajectory based on determining the at least one of the probability of the violation of the behavioral rule is greater than or matches the first threshold value or the distance from the violation of the behavioral rule is less than or matches the second threshold value.

Clause 23: The system of Clause 20 or Clause 22, wherein execution of the instructions by the at least one processor further causes the at least one processor to:
determine at least one of the probability of the violation of the behavioral rule is less than a first threshold value or the distance from the violation of the behavioral rule is greater than a second threshold value,
wherein to select the particular trajectory from the first trajectory and the second trajectory, the execution of the instructions by the at least one processor further causes the at least one processor to:
select the first trajectory from the first trajectory and the second trajectory based on determining at least one of the probability of the violation of the behavioral rule is less than the first threshold value or the distance from the violation of the behavioral rule is greater than the second threshold value.

Clause 24: The system of any one of Clause 20, Clause 22, or Clause 23, wherein to generate the first trajectory, execution of the instructions by the at least one processor further causes the at least one processor to:
generate the first trajectory based on a first set of sensor data associated with a sensor of the vehicle, and
wherein to generate the second trajectory, the execution of the instructions by the at least one processor further causes the at least one processor to:
generate the second trajectory based on a second set of sensor data associated with the sensor,
wherein the execution of the instructions by the at least one processor further causes the at least one processor to:
obtain the first set of sensor data corresponding to a first time period; and
obtain the second set of sensor data corresponding to a second time period, wherein the second time period is subsequent to the first time period.

Clause 25: The system of any one of Clause 20 or Clauses 22 through 24, wherein to generate the first trajectory, execution of the instructions by the at least one processor further causes the at least one processor to:
generate the first trajectory based on a first set of sensor data associated with a sensor of the vehicle, and
wherein to generate the second trajectory, the execution of the instructions by the at least one processor further causes the at least one processor to:
generate the second trajectory based on a second set of sensor data associated with the sensor,
wherein the execution of the instructions by the at least one processor further causes the at least one processor to:
obtain the first set of sensor data; and
obtain an update to the first set of sensor data comprising the second set of sensor data.

Clause 26: The system of any one of Clause 20 or Clauses 22 through 25, wherein to generate the first trajectory, execution of the instructions by the at least one processor further causes the at least one processor to:
generate the first trajectory from a first pose to a second pose, and
wherein to generate the second trajectory, the execution of the instructions by the at least one processor further causes the at least one processor to: generate the second trajectory from the first pose to a third pose.

Clause 27: The system of any one of Clause 20 or Clauses 22 through 26, wherein to determine the at least one of the probability of or the distance from the violation of the behavioral rule by the vehicle, execution of the instructions by the at least one processor further causes the at least one processor to at least one of:
determine a probability of at least one of a collision or a clearance violation by the vehicle;
determine a physical distance between a position of the vehicle and a position of at least one of a collision or a clearance violation by the vehicle; or
determine a distance with respect to time of at least one of a collision or a clearance violation by the vehicle.

Clause 28: The system of any one of Clause 20 or Clauses 22 through 27, wherein to generate the second trajectory, execution of the instructions by the at least one processor further causes the at least one processor to:
generate a turning trajectory; or
generate a braking trajectory.

Clause 29: The system of any one of Clause 20 or Clauses 22 through 28, wherein to generate the second trajectory, execution of the instructions by the at least one processor further causes the at least one processor to:
generate the second trajectory based on generating the first trajectory.

Clause 30: The system of any one of Clause 20 or Clauses 22 through 29, wherein to generate the second trajectory, execution of the instructions by the at least one processor further causes the at least one processor to:
obtain a set of sensor data; and
generate the second trajectory based on obtaining the set of sensor data.

Clause 31: The system of any one of Clause 20 or Clauses 22 through 30, wherein to generate the first trajectory, execution of the instructions by the at least one processor further causes the at least one processor to:
generate the first trajectory using a first trajectory generator,
wherein to generate the second trajectory, the execution of the instructions by the at least one processor further causes the at least one processor to:
generate the second trajectory using a second trajectory generator.

Clause 32: The system of any one of Clause 20 or Clauses 22 through 31, wherein to generate the first trajectory, execution of the instructions by the at least one processor further causes the at least one processor to:
generate the first trajectory using a first trajectory generator at a first frequency,
wherein to generate the second trajectory, the execution of the instructions by the at least one processor further causes the at least one processor to:
generate the second trajectory using a second trajectory generator at a second frequency greater than the first frequency.

Clause 33: The system of Clause 20 or Clauses 22 through 32, wherein execution of the instructions by the at least one processor further causes the at least one processor to:
transmit a message to a control system of the vehicle to operate the vehicle based on the path for the vehicle.

Clause 34: The system of Clause 20 or Clauses 22 through 33, wherein execution of the instructions by the at least one processor further causes the at least one processor to:
transmit the first trajectory and the second trajectory to a control system of the vehicle; and
transmit a message to a control system of the vehicle to operate the vehicle based on the path for the vehicle.

Clause 35: The system of Clause 20 or Clauses 22 through 34, wherein execution of the instructions by the at least one processor further causes the at least one processor to:
transmit the particular trajectory and an alternative trajectory to a control system of the vehicle, wherein the particular trajectory and the alternative trajectory each comprise the second trajectory; and
transmit a message to a control system of the vehicle to operate the vehicle based on the path for the vehicle.

Clause 36: The system of any one of Clause 20 or Clauses 22 through 35, wherein to generate the first trajectory, execution of the instructions by the at least one processor further causes the at least one processor to:
generate the first trajectory based on at least one of a first planner objective or a first cost function,
wherein to generate the second trajectory, the execution of the instructions by the at least one processor further causes the at least one processor to:
generate the second trajectory based on least one of a second planner objective or a second cost function.

Clause 37: The system of any one of Clause 20 or Clauses 22 through 36, wherein to generate the first trajectory, execution of the instructions by the at least one processor further causes the at least one processor to:
generate the first trajectory using a first trajectory generator, and
wherein to generate the second trajectory, the execution of the instructions by the at least one processor further causes the at least one processor to:
generate the second trajectory using a second trajectory generator,
wherein the execution of the instructions by the at least one processor further causes the at least one processor to:
determine at least one of the probability of the violation of the behavioral rule is less than a first threshold value or the distance from the violation of the behavioral rule is greater than a second threshold value, wherein to select the particular trajectory from the first trajectory and the second trajectory, the execution of the instructions by the at least one processor further causes the at least one processor to select the first trajectory from the first trajectory and the second trajectory based on determining the at least one of the probability of the violation of the behavioral rule is less than the first threshold value or the distance from the violation of the behavioral rule is greater than the second threshold value;
determine at least one of a second probability of the violation of the behavioral rule is greater than or matches the first threshold value or a second distance from the violation of the behavioral rule is less than or matches the second threshold value;
select a third trajectory generated by the second trajectory generator based on determining the at least one of the second probability of the violation of the behavioral rule is greater than or matches the first threshold value or the second distance from the violation of the behavioral rule is less than or matches the second threshold value; and
determine a second path for the vehicle to operate along based on selecting the third trajectory.

Clause 38: The system of any one of Clause 20 or Clauses 22 through 37, wherein to select the particular trajectory from the first trajectory and the second trajectory, execution of the instructions by the at least one processor further causes the at least one processor to:
select the first trajectory from the first trajectory and the second trajectory based on determining the at least one of the probability of or the distance from the violation of the behavioral rule by the vehicle is less than a threshold value, wherein selection of the first trajectory is overridden based on a set of sensor data associated with a sensor.

Clause 39: The system of any one of Clause 20 or Clauses 22 through 38, wherein the first set of criterion comprises at least one of a first set of sensor data associated with a sensor, a first cost function, or a first planning objective, wherein the second set of criterion comprises at least one of a second set of sensor data associated with the sensor or a safety objective, and wherein the first set of criterion and the second set of criterion comprise different criterion.

Clause 40: The at least one non-transitory storage media of Clause 21, wherein execution of the instructions by the computing system further causes the computing system to:
determine at least one of the probability of the violation of the behavioral rule is greater than or matches a first threshold value or the distance from the violation of the behavioral rule is less than or matches a second threshold value,
wherein to select the particular trajectory from the first trajectory and the second trajectory, the execution of the instructions by the computing system further causes the computing system to:
select the second trajectory from the first trajectory and the second trajectory based on determining the at least one of the probability of the violation of the behavioral rule is greater than or matches the first threshold value or the distance from the violation of the behavioral rule is less than or matches the second threshold value.

Clause 41: The at least one non-transitory storage media of Clause 21 or Clause 40, wherein execution of the instructions by the computing system further causes the computing system to:
determine at least one of the probability of the violation of the behavioral rule is less than a first threshold value or the distance from the violation of the behavioral rule is greater than a second threshold value,
wherein to select the particular trajectory from the first trajectory and the second trajectory, the execution of the instructions by the computing system further causes the computing system to:
select the first trajectory from the first trajectory and the second trajectory based on determining at least one of the probability of the violation of the behavioral rule is less than the first threshold value or the distance from the violation of the behavioral rule is greater than the second threshold value.

Clause 42: The at least one non-transitory storage media of any one of Clause 22, Clause 40, or Clause 41, wherein to generate the first trajectory, execution of the instructions by the computing system further causes the computing system to:
generate the first trajectory based on a first set of sensor data associated with a sensor of the vehicle, and
   wherein to generate the second trajectory, the execution of the instructions by the computing system further causes the computing system to:
generate the second trajectory based on a second set of sensor data associated with the sensor,
wherein the execution of the instructions by the computing system further causes the computing system to:
obtain the first set of sensor data corresponding to a first time period; and
obtain the second set of sensor data corresponding to a second time period, wherein the second time period is subsequent to the first time period.

Clause 43: The at least one non-transitory storage media of any one of Clause 21 or Clauses 40 through 42, wherein to generate the first trajectory, execution of the instructions by the computing system further causes the computing system to:
generate the first trajectory based on a first set of sensor data associated with a sensor of the vehicle, and
wherein to generate the second trajectory, the execution of the instructions by the computing system further causes the computing system to:
generate the second trajectory based on a second set of sensor data associated with the sensor,
wherein the execution of the instructions by the computing system further causes the computing system to:
obtain the first set of sensor data; and
obtain an update to the first set of sensor data comprising the second set of sensor data.

Clause 44: The at least one non-transitory storage media of any one of Clause 21 or Clauses 40 through 43, wherein to generate the first trajectory, execution of the instructions by the computing system further causes the computing system to:
generate the first trajectory from a first pose to a second pose, and
wherein to generate the second trajectory, the execution of the instructions by the computing system further causes the computing system to:
generate the second trajectory from the first pose to a third pose.

Clause 45: The at least one non-transitory storage media of any one of Clause 21 or Clauses 40 through 44, wherein to determine the at least one of the probability of or the distance from the violation of the behavioral rule by the vehicle, execution of the instructions by the computing system further causes the computing system to at least one of:
determine a probability of at least one of a collision or a clearance violation by the vehicle;
determine a physical distance between a position of the vehicle and a position of at least one of a collision or a clearance violation by the vehicle; or
determine a distance with respect to time of at least one of a collision or a clearance violation by the vehicle.

Clause 46: The at least one non-transitory storage media of any one of Clause 21 or Clauses 40 through 45, wherein to generate the second trajectory, execution of the instructions by the computing system further causes the computing system to:
generate a turning trajectory; or
generate a braking trajectory.

Clause 47: The at least one non-transitory storage media of any one of Clause 21 or Clauses 40 through 46, wherein to generate the second trajectory, execution of the instructions by the computing system further causes the computing system to:
generate the second trajectory based on generating the first trajectory.

Clause 48: The at least one non-transitory storage media of any one of Clause 21 or Clauses 40 through 47, wherein to generate the second trajectory, execution of the instructions by the computing system further causes the computing system to:
obtain a set of sensor data; and
generate the second trajectory based on obtaining the set of sensor data.

Clause 49: The at least one non-transitory storage media of any one of Clause 21 or Clauses 40 through 48, wherein to generate the first trajectory, execution of the instructions by the computing system further causes the computing system to:
generate the first trajectory using a first trajectory generator,
wherein to generate the second trajectory, the execution of the instructions by the computing system further causes the computing system to:
generate the second trajectory using a second trajectory generator.

Clause 50: The at least one non-transitory storage media of any one of Clause 21 or Clauses 40 through 49, wherein to generate the first trajectory, execution of the instructions by the computing system further causes the computing system to:
generate the first trajectory using a first trajectory generator at a first frequency,
wherein to generate the second trajectory, the execution of the instructions by the computing system further causes the computing system to:
generate the second trajectory using a second trajectory generator at a second frequency greater than the first frequency.

Clause 51: The at least one non-transitory storage media of any one of Clause 21 or Clauses 40 through 50, wherein execution of the instructions by the computing system further causes the computing system to:
transmit a message to a control system of the vehicle to operate the vehicle based on the path for the vehicle.

Clause 52: The at least one non-transitory storage media of any one of Clause 21 or Clauses 40 through 51, wherein execution of the instructions by the computing system further causes the computing system to:
transmit the first trajectory and the second trajectory to a control system of the vehicle; and
transmit a message to a control system of the vehicle to operate the vehicle based on the path for the vehicle.

Clause 53: The at least one non-transitory storage media of any one of Clause 21 or Clauses 40 through 52, wherein execution of the instructions by the computing system further causes the computing system to:
transmit the particular trajectory and an alternative trajectory to a control system of the vehicle, wherein the particular trajectory and the alternative trajectory each comprise the second trajectory; and
transmit a message to a control system of the vehicle to operate the vehicle based on the path for the vehicle.

Clause 54: The at least one non-transitory storage media of any one of Clause 21 or Clauses 40 through 53, wherein to generate the first trajectory, execution of the instructions by the computing system further causes the computing system to:
generate the first trajectory based on at least one of a first planner objective or a first cost function,
wherein to generate the second trajectory, the execution of the instructions by the computing system further causes the computing system to:
generate the second trajectory based on least one of a second planner objective or a second cost function.

Clause 55: The at least one non-transitory storage media of any one of Clause 21 or Clauses 40 through 54, wherein to generate the first trajectory, execution of the instructions by the computing system further causes the computing system to:
generate the first trajectory using a first trajectory generator, and
wherein to generate the second trajectory, the execution of the instructions by the computing system further causes the computing system to:
generate the second trajectory using a second trajectory generator,
wherein the execution of the instructions by the computing system further causes the computing system to:
determine at least one of the probability of the violation of the behavioral rule is less than a first threshold value or the distance from the violation of the behavioral rule is greater than a second threshold value, wherein to select the particular trajectory from the first trajectory and the second trajectory, the execution of the instructions by the computing system further causes the computing system to select the first trajectory from the first trajectory and the second trajectory based on determining the at least one of the probability of the violation of the behavioral rule is less than the first threshold value or the distance from the violation of the behavioral rule is greater than the second threshold value;
determine at least one of a second probability of the violation of the behavioral rule is greater than or matches the first threshold value or a second distance from the violation of the behavioral rule is less than or matches the second threshold value;
select a third trajectory generated by the second trajectory generator based on determining the at least one of the second probability of the violation of the behavioral rule is greater than or matches the first threshold value or the second distance from the violation of the behavioral rule is less than or matches the second threshold value; and
determine a second path for the vehicle to operate along based on selecting the third trajectory.

Clause 56: The at least one non-transitory storage media of any one of Clause 21 or Clauses 40 through 55, wherein to select the particular trajectory from the first trajectory and the second trajectory, execution of the instructions by the computing system further causes the computing system to:
select the first trajectory from the first trajectory and the second trajectory based on determining the at least one of the probability of or the distance from the violation of the behavioral rule by the vehicle is less than a threshold value, wherein selection of the first trajectory is overridden based on a set of sensor data associated with a sensor.

Clause 57: The at least one non-transitory storage media of any one of Clause 20 or Clauses 22 through 56, wherein the first set of criterion comprises at least one of a first set of sensor data associated with a sensor, a first cost function, or a first planning objective, wherein the second set of criterion comprises at least one of a second set of sensor data associated with the sensor or a safety objective, and wherein the first set of criterion and the second set of criterion comprise different criterion.

1. A method comprising:
generating, using at least one processor, a first trajectory for a vehicle based on a first set of criterion;
generating, using the at least one processor, a second trajectory for the vehicle based on a second set of criterion different from the first set of criterion;
determining, using the at least one processor, at least one of a probability of a violation of a behavioral rule by the vehicle or a distance from the violation of the behavioral rule;
selecting, using the at least one processor, a particular trajectory from the first trajectory and the second trajectory based on the at least one of the probability of the violation of the behavioral rule or the distance from the violation of the behavioral rule; and
determining, using the at least one processor, a path for the vehicle to operate along based on the particular trajectory.

2. The method of claim 1, further comprising:
determining at least one of the probability of the violation of the behavioral rule is greater than or matches a first threshold value or the distance from the violation of the behavioral rule is less than or matches a second threshold value,
wherein selecting the particular trajectory from the first trajectory and the second trajectory comprises:
selecting the second trajectory from the first trajectory and the second trajectory based on determining the at least one of the probability of the violation of the behavioral rule is greater than or matches the first threshold value or the distance from the violation of the behavioral rule is less than or matches the second threshold value.

3. The method of claim 1, further comprising:
determining at least one of the probability of the violation of the behavioral rule is less than a first threshold value or the distance from the violation of the behavioral rule is greater than a second threshold value,
wherein selecting the particular trajectory from the first trajectory and the second trajectory comprises:
selecting the first trajectory from the first trajectory and the second trajectory based on determining at least one of the probability of the violation of the behavioral rule is less than the first threshold value or the distance from the violation of the behavioral rule is greater than the second threshold value.

4. The method of claim 1, wherein generating the first trajectory comprises:
generating the first trajectory based on a first set of sensor data associated with a sensor of the vehicle, and
wherein generating the second trajectory comprises:
generating the second trajectory based on a second set of sensor data associated with the sensor,
the method further comprising:
obtaining the first set of sensor data corresponding to a first time period; and
obtaining the second set of sensor data corresponding to a second time period,
wherein the second time period is subsequent to the first time period.

5. The method of claim 1, wherein generating the first trajectory comprises:
generating the first trajectory based on a first set of sensor data associated with a sensor of the vehicle, and
wherein generating the second trajectory comprises:
generating the second trajectory based on a second set of sensor data associated with the sensor,
the method further comprising:
obtaining the first set of sensor data; and
obtaining an update to the first set of sensor data comprising the second set of sensor data.

6. The method of claim 1 wherein generating the first trajectory comprises:
generating the first trajectory from a first pose to a second pose, and
wherein generating the second trajectory comprises:
generating the second trajectory from the first pose to a third pose.

7. The method of claim 1, wherein determining the at least one of the probability of the violation of the behavioral rule or the distance from the violation of the behavioral rule comprises at least one of:
determining a probability of at least one of a collision or a clearance violation by the vehicle;
determining a physical distance between a position of the vehicle and a position of at least one of a collision or a clearance violation by the vehicle; or
determining a distance with respect to time of at least one of a collision or a clearance violation by the vehicle.

8. The method of claim 1, wherein generating the second trajectory comprises:
generating a turning trajectory; or
generating a braking trajectory.

9. The method of claim 1, wherein generating the second trajectory comprises:
generating the second trajectory based on generating the first trajectory.

10. The method of claim 1, wherein generating the second trajectory comprises:
obtaining a set of sensor data; and
generating the second trajectory based on obtaining the set of sensor data.

11. The method of claim 1, wherein generating the first trajectory comprises:
generating the first trajectory using a first trajectory generator,
wherein generating the second trajectory comprises:
generating the second trajectory using a second trajectory generator.

12. The method of claim 1, wherein generating the first trajectory comprises:
generating the first trajectory using a first trajectory generator at a first frequency,
wherein generating the second trajectory comprises:
generating the second trajectory using a second trajectory generator at a second frequency greater than the first frequency.

13. (canceled)

14. The method of claim, further comprising:
transmitting the first trajectory and the second trajectory to a control system of the vehicle; and
transmitting a message to a control system of the vehicle to operate the vehicle based on the path for the vehicle.

15. The method of claim further comprising:
transmitting the particular trajectory and an alternative trajectory to a control system of the vehicle, wherein the particular trajectory and the alternative trajectory each comprise the second trajectory; and
transmitting a message to a control system of the vehicle to operate the vehicle based on the path for the vehicle.

16. The method of claim 1, wherein generating the first trajectory comprises:
generating the first trajectory based on at least one of a first planner objective or a first cost function,
wherein generating the second trajectory comprises:
generating the second trajectory based on least one of a second planner objective or a second cost function.

17. The method of claim 1 wherein generating the first trajectory comprises:
generating the first trajectory using a first trajectory generator, and
wherein generating the second trajectory comprises:
generating the second trajectory using a second trajectory generator different from the first trajectory generator,
the method further comprising:
determining at least one of the probability of the violation of the behavioral rule is less than a first threshold value or the distance from the violation of the behavioral rule is greater than a second threshold value, wherein selecting the particular trajectory from the first trajectory and the second trajectory comprises selecting the first trajectory from the first trajectory and the second trajectory based on determining the at least one of the probability of the violation of the behavioral rule is less than the first threshold value or the distance from the violation of the behavioral rule is greater than the second threshold value;
determining at least one of a second probability of the violation of the behavioral rule is greater than or matches the first threshold value or a second distance from the violation of the behavioral rule is less than or matches the second threshold value;
selecting a third trajectory generated by the second trajectory generator based on determining the at least one of the second probability of the violation of the behavioral rule is greater than or matches the first threshold value or the second distance from the violation of the behavioral rule is less than or matches the second threshold value; and
determining a second path for the vehicle to operate along based on selecting the third trajectory.

18. The method of claim 1, wherein selecting the particular trajectory from the first trajectory and the second trajectory comprises:
selecting the first trajectory from the first trajectory and the second trajectory based on determining the at least one of the probability of or the distance from the violation of the behavioral rule by the vehicle is less than a threshold value, wherein selection of the first trajectory is overridden based on a set of sensor data associated with a sensor.

19. The method of claim 1, wherein the first set of criterion comprises at least one of a first set of sensor data associated with a sensor, a first cost function, or a first planning objective, and wherein the second set of criterion comprises at least one of a second set of sensor data associated with the sensor or a safety objective.

20. A system comprising:
at least one processor, and
at least one non-transitory storage media storing instructions that, when executed by the at least one processor, cause the at least one processor to:
generate a first trajectory for a vehicle based on a first set of criterion;
generate a second trajectory for the vehicle based on a second set of criterion different from the first set of criterion;
determine at least one of a probability of or a distance from a violation of a behavioral rule by the vehicle;
select a particular trajectory from the first trajectory and the second trajectory based on the at least one of the probability of or the distance from the violation of the behavioral rule; and
determine a path for the vehicle to operate along based on the particular trajectory.

21. At least one non-transitory storage media storing instructions that, when executed by a computing system comprising a processor, cause the computing system to:
generate a first trajectory for a vehicle based on a first set of criterion;
generate a second trajectory for the vehicle based on a second set of criterion different from the first set of criterion;
determine at least one of a probability of or a distance from a violation of a behavioral rule by the vehicle;
select a particular trajectory from the first trajectory and the second trajectory based on the at least one of the probability of or the distance from the violation of the behavioral rule; and
determine a path for the vehicle to operate along based on the particular trajectory.
